(19) United States
(12) Patent Application Publication
(10) Pub. No.: US 2017/0191301 A1
(43) Pub. Date: Jul. 6, 2017

(54) DRIVE DEVICE FOR A DOOR

(71) Applicant: NOVOFERM TORMATIC GMBH, Dortmund (DE)

(72) Inventors: Michael GLANZ, Langenfeld (DE); Michael HAMACHER, Ennepetal (DE); Jonas DEICKE, Dortmund (DE); Ulrich THEILE, Hagen (DE); Ralf SOJKA, Schwerte (DE)

(73) Assignee: NOVOFERM TORMATIC GMBH, Dortmund (DE)

(21) Appl. No.: 15/314,642

(22) PCT Filed: Jun. 13, 2015
(86) PCT No.: PCT/EP2015/001203

§ 371 Date: Nov. 29, 2016

(30) Foreign Application Priority Data
Jun. 16, 2014 (DE) 10 2014 008 542.2
Jul. 12, 2014 (DE) 10 2014 010 275.0
Jul. 12, 2014 (DE) 10 2014 010 277.7
Mar. 18, 2015 (DE) 10 2015 003 395.6
Mar. 18, 2015 (DE) 10 2015 003 396.4
Mar. 18, 2015 (DE) 10 2015 003 397.2
Mar. 31, 2015 (DE) 10 2015 004 080.4
Jun. 8, 2015 (DE) 10 2015 007 091.6

(51) Int. Cl. E05F 15/668; E05F 15/00

(52) U.S. Cl. CPC E05F 15/668; E05F 15/00; E05Y 2201/684

(57) ABSTRACT

The invention relates to a drive device (1), essentially including a motor (26) and a gearbox (27, 83) and a control system (123), for the automation of a door, preferably a garage door, with a connection (120) to a force transmitting means (46) revolving within the drive track (4) and driven by means of the motor (26), wherein the gearbox (27, 83) includes a worm (29) and is equipped with two opposing motor connectors (57, 58), to which selectively a motor (26) or (28) or simultaneously both motors (26, 28) can be connected, wherein the motors (26, 28) act upon the common worm (79), the rotational movement thereof being transferred onto a worm wheel (100), which directly or indirectly acts like a gearbox onto the force transmitting means (46).

The invention relates to a drive device for the automation of a door, preferably a garage door, which device essentially includes a motor, a gearbox and a control system. Moreover, such a drive device is equipped with a drive track, in which revolving force transmitting means are provided, which is driven by the motor.

A device for a door drive, in particular for rolling doors, sectional doors with a door moving element, in which the door drive comprises at least two electrical motors, is known from the document DE 202 009 006 587 U1. Among the two electrical motors, the one is firmly connected directly or indirectly to the connection means, which is disposed at the door moving element, and all further electrical motors are radially disposed around the door moving element and connected to the latter via the connecting element. The document DE 25 49 395 A1 likewise discloses an apparatus for opening doors, in which two drive motors are supported at the door leaf.

The document DE 20 2011 107 685 U1 discloses a drive device for an automated door or the like, which is affixed to the free protruding end of the drive track. In this case, the end of a drive track extends far beyond the rear plane of the drive device and is connected to the drive device by means of overlapping brackets. Within the drive track, revolving driving means are provided, which is driven by means of a driven pinion, which protrudes from the drive device. The driving means are configured as a toothed belt for allowing to perform an opening, respectively a closing of the door.

The document U.S. Pat. No. 8,689,486 B2 describes the termination of a drive track at a drive, in which overlapping brackets are employed for the attachment of the drive track to the drive head. The driving means are connected to the latter by means of a toothed wheel associated to the drive device.

A sensor for exactly detecting the position of a door in a motor-driven door is known from the document DE 20 2004 000 851 U1. In this case, the sensor consists of a light barrier, a synchronous perforated disc with an increment perforation in a disc and a double epicyclical gearing, which guarantees the necessary step-up ratio for the synchronous perforated disc.

A motor driven apparatus for opening and closing a door is indicated in the document DE 203 09 496 U1. This drive unit is composed of a motor in conjunction with a gearbox unit. However, in this case, the gearbox unit is not placed within the drive unit, but incorporated frontally into the drive track. A drive worm, which transfers the rotary movement of the motor to an intermediate chain pinion and further onto an intermediate chain wheel, is driven by the motor disposed below the drive track and thereby below the gearbox, i.e. by means of a belt wheel.

For the purpose of being able of illuminating a garage or the like, garage door drive devices are equipped with illumination apparatuses. In this case, the document DE 20 2004 018 115 U1 discloses electrical light bulbs, which are disposed next to the electrical garage door drive. In the document DE 20 2005 000 349 U1, light-emitting diodes are employed in one part of the housing of the garage door drive.

The document DE 20 2005 000 590 U1 discloses an illumination for door drives, which is incorporated into a housing for the door dive, and utilizes an electroluminescence radiator as lighting means. In this case, light-emitting diodes in the shape of individual light-emitting diodes and also in the shape of clusters are utilized. In addition to the pure illumination task, also instructions can be emitted to other visually reachable command elements on account of the high-frequency timing of the lighting means. In this case, in addition to a light-permeable area of the hood, which serves for illuminating the room, at least one further light-permeable area is provided, by means of which the clocked light can be uncoupled by means of a light guide and conducted to a light-permeable area of the hood.

Furthermore, illumination devices, respectively illumination modules in various embodiments are revealed in the documents DE 20 2013 103 294 U1, the document DE 20 2011 050 596 U1 as well as the document DE 20 2011 050 253 U1.

The document DE 94 03 746 U1 describes a device for opening and closing doors. In this case, at a frontal side a rectangular running track penetrates into an opening of the device and, above the motor and the gearbox, is laterally pushed onto a drive unit support, which is connected to the gearbox, and thereafter immobilized by means of a screw. A pinion, which is connected to an output shaft of the gearing, extends within the support for the drive unit. Said structure is covered altogether by a housing. Such an embodiment of the structure is absolutely equivalent to the connections known from the state-of-the-art, which are fitted above the drive devices. When compared to the prior art devices, a reduction of the structural height is not noticed in this device.

Based on their exterior housing, the drive units for door drives available on the market today have a very large, bulky built external shape. Such a shape considerably delimits the overall height within the building, in which the drive device is mounted below a ceiling. Furthermore, the drive units for doors become increasingly smaller and should nevertheless be employed for the most different door sizes. Basically, this requirement demands tremendous stock keeping, because depending on the door size and door weight, the most different drive devices need to be kept in stock. In particular based on the circumstance that also the buildings, in which such drive devices are being employed, increasingly consist of pre-fabricated parts, the commercially available drive devices for garage door drives or the like may run into the problem that the drive devices in their height extension are built too high and thereby reduce the passage height within the garage or the like.

The object of the invention is to provide a drive device, which offers the possibility of being employed for the most different application cases with doors, in particular with garage doors. This means that the drive device must also be able to serve for the most different performance classes, for example in terms of weight of the door leaf. Furthermore, such a drive device should be manufactured at low cost and its structural height should present small dimensions such that, based on the small exterior dimensions, the drive device can be utilized in all installation locations. This relates in particular to the connection between a drive track and the drive device, in which, based on the installation between the drive track and drive device, no reduction of the available overall height within the garage or the like should occur. Furthermore, an installation method should be provided, which can be performed by laymen. This method should also be applicable to prior existing drive tracks, in the event the drive device would be exchanged.

The problem of the invention is solved by the features of patent claim 1. In this context the dependent claims present another configuration of the inventive idea.

The inventive drive unit includes a two-part housing, which is composed of a lower housing part and an upper housing part. In both housing parts any protruding devices or protruding structural components are foregone. Preferably, the border areas of the housing underside include circumferential roundings or other harmonious shapes, which subsequently may essentially merge into straight lateral sections. Simultaneously, said straight lateral sections form the connection area between the lower housing part and the upper housing part. Essentially, the basic form of the housing consists of a rectangular or of a square configuration. A mounting base, to which the interior components of the drive device may be attached, may be disposed at the upper housing part at the housing upper side. Simultaneously, said mounting base offers the possibility of providing an adjoining area for the drive track. Thus, the drive track is not connected in a bulky manner on the rear side area of the mounting base, which would inevitably result in increasing the height extension of the drive device. The drive device is rather joined in a butt-type to the drive unit at or via a frontal side.

It should be understood, that in a further preferred embodiment the housing back side itself might be simultaneously configured for mounting the structural elements, which are contained in the drive device. In such a case, also the housing back side may include an adjoining area for a butt-type connection to the drive track.

By affixing the drive track to a frontal side of the drive device, i. e. practically butt joint to head, a connection type is created, in which the drive track does not necessarily have to project into the drive device or also just insignificantly projects into it. Such a connection may be for example executed in that the mounting base is configured in that an attachment reception ensures the connection between the drive track and the drive device.

On account of the attachment type of the drive track practically in front of a frontal side of the drive device, the entire construction height of the drive device is considerably reduced. Preferably, the connection to the drive track is realized via retaining protrusions, which are inserted into oblong holes of the drive track and are subsequently displaced in that the drive track at the end side abuts against a wall of a connecting part, which forms the connection between the drive track and the drive device, and is simultaneously reliably connected to the connecting part. In the area of the wall on the opposite side, the possibility is given of realizing the connection to the drive device or to parts of the drive device by means of a screw connection.

The drive device in question for the most different applications, in which the most different force ratios may occur, includes a gearbox, which offers the possibility of employing optionally one or two motors. In this case, such a gearbox preferably includes a straight base, which is surrounded by opposing sidewalls. In this case, one sidewall at the head is configured as a closed frontal wall and the opposite sidewall is configured as an open or partially open exit side. The open or partially open configuration allows for a passage of the force transmitting means, which from the drive point of view is driven within the gearbox.

The revolving force transmitting means, within the drive track, is preferably formed by means of a toothed belt or a chain, and in this case is driven by a driving wheel, which is for example rotatably supported within the drive device or the gearbox.

Furthermore, one of the sidewalls includes an extension, in which a worm is embedded rotatably supported in a horizontal configuration. By placing the worm into such an extension, the possibility is given of flanging one or but also two motors to the worm. Thereby, depending on the application location, the performance of the drive device can be modified. With smaller doors, only one motor may be employed, which will reduce the cost. For connecting the motors, the worm includes a reception for spindle inserts at its respective ends, which spindle inserts, at the other end, are connected to the respective motor.

A connection to the gearbox housing is established via the motor housings. Thus, in the event of an incident or during a failure of one of the motors, the latter may be exchanged without any problems. In this case, electrical energy is supplied to the motors from a common control system.

Bearings for the reception of axes are contained in the base bottom of the gearbox, wherein one of the axes accommodates a worm wheel, which is in direct engagement with a worm. The configuration of the worm wheel may be embodied in that for example additionally a protruding spur gearing is provided, onto which a transmission wheel is placed. Said transmission wheel enables transforming the rotational movement, which was generated by means of the worm drive, from an axial movement into a radial rotational movement. Simultaneously, a change of the rotational speed can be achieved. In this case, the transmission wheel interacts as a gearing with an output wheel, which is supported on a further axis within the base. The drive wheel may be likewise connected to the output wheel for a force transmitting means via a spur gearing. As illustrated by the embodiment of this structure, such an arrangement of gearing parts, in addition to the connecting possibility of one or two motors, also achieves a very flat configuration of the gearbox.

For realizing a determination of the rotational speeds of the gearbox and thereby also at the same time a position detection, a measuring device for determining the rotational speed may be disposed within the gearbox. Such a measuring device may be configured for example in the shape of a measuring wheel in conjunction with a light barrier. However, there is also the possibility of disposing a permanent magnet for example within the toothed wheels, which magnet is in operational connection with a Hall generator for detecting the revolutions.

In a further preferred embodiment, it is possible not to drive the force transmitting means directly within the gearbox, but rather to split the gearbox into a driving part and a transmitting part. In this case, the driving part of the gearbox in the shape of the disposition of the worm is associated to the worm wheel as well as to the transmitting wheel. In this case, the transmitting part is associated to the drive track. Such a procedure may considerably reduce the mounting times, because pre-mounting within the factory is possible. Moreover, it is also possible that mounting errors are thereby avoided. The basic idea in this case consists in that a geared configuration or disposition is selected, which essentially consists of a gearbox, which however simultaneously includes an interface for the connection to the drive track. Such a connection is distinguished by a non-positive and positive connection. Practically, a division of the above-described gearbox is realized.

The division into a driving part and a transmitting part offers different possibilities for the configuration of the transmitting part. On the one hand, the transmitting part is non-positively and positively connected to the drive track, and on the other hand, a non-positive and positive connection to the gearbox is established in the area of the connecting part. Such a connection may be achieved for example by means of lateral protrusions at the connecting part, which engage into complementary recesses within the gearbox. After joining the connecting part to the gearbox, existing attachment possibilities are realized by means of screw connections. Such a connection of the drive track does not require any increase in the structural height of the drive device.

With the intention to drive the force transmitting means within the drive track, an axis, which includes a redirection roller for the force transmitting means, is rotatably supported in the connecting part. In this case, the axis protrudes beyond the redirection roller, such as to be able to place a transmission wheel onto the common axis. Said transmission wheel engages with the output wheel, which is provided in the gearbox, via their tooth systems, after joining both components. Thus, the rotation of the worm is able to move the force transmitting means within the drive track and thereby by means of a catch member, which is connected to the force transmitting means, to translationally move within the drive track.

The parts of the driving part and of the transmitting part, which are non-positively and positively connected to each other after joining, may be additionally secured by a lateral attachment, respectively at the top side to the drive housing in addition to the latch connections, also by means of screw connections.

As revealed in this embodiment, such a configuration of the gearbox arrangement with the connection possibility of two motors allows for achieving an overall flat configuration, because also in this case, the drive track is disposed in a butt-type in front of the gearbox. Such a compact configuration of the gearbox arrangement, composed of the driving part and of the transmitting part, may be cost-effectively manufactured from injection moulding or else from plastic material and thereby offers different application possibilities.

The intelligent division in two of the housing of the drive unit allows for example for embodying the lower housing part altogether or partially as an illumination unit. Such an illumination unit may include a planar radiation surface, which realizes a homogenous illumination by means of a reflector and incorporated light-emitting diodes. The radiation surface is for example closed off by means of a light permeable covering.

The reflector may be delimited on the exterior side for example by means of a circumferential frame. A radiation unit with light-emitting diodes may be provided at the frame. In this case, the radiation unit is controlled by means of the electronic control system contained within the drive device. As the entire radiation surface consists for example of translucent plastic material, not only a partial light-permeable embodiment is created in front of the arrangement of the lighting means, but a large surface illumination, which may extend over the entire underside of the drive device. Preferably, the radiation surface is connected to a frame, via which the reflector is simultaneously connected to be exchangeable.

In addition to a configuration with light-emitting diodes, also a light guide may be possibly employed for generating the light radiation. Transparent structural components are referred to as light guides, which at their border surfaces and via reflections emit a total reflection to the surrounding medium, which total reflection is based on a lower refractive index. Such a light guide may as well be referred to as optical fibre. In this case, also planar light guide structures are applicable.

In addition to a two-dimensional homogenous illumination of the radiation surface, it is also possible that the utilization of an additional light guide generates an atmosphere of relaxation by means of combining colour and light. Based on individual sensations of well-being, a custom-tailored additional illumination apparatus is created. This can be achieved in that the additional light guide, in the shape of a light band, is placed at the edges of the radiation surface. Supplying electric energy may be realized from the same radiation unit or also from a separate radiation unit. In this case, the illumination colour in different colour spectra should be preferably realized in a blue range.

In a further preferred embodiment, it is possible that electronics, which in addition to displays also include push-buttons, be provided within the radiation surface. Said arrangement may be embodied in a preferred embodiment by means of a transparent printed execution. Such push-buttons may be incorporated as capacitive push-buttons into the radiation surface, which is preferably made from plastic material. Such an embodiment of displays or push-buttons, which may serve for manipulating, respectively for programming the drive device, is linked to the electronic control system of the drive unit via flexible electric connections.

With the intention to enhance the value of the insignificant appearance of the grey drive track, a superior surface solution in the shape of a coloured design is chosen. Such a surface embodiment provides an up-valued aesthetical appearance to the drive track. In this case, individually customer specifications can be considered in that they select their own suitable colours from an existing assortment, optionally for example from RAL-colours. Thereby, primarily a large decoration variety having different design elements is achieved. In addition to an embodiment in a varnished form, said elements may be embodied also in a powder coating. In this case, in particular mineral materials in pure white or black are of particular importance. Thus, elegant nuanced colour shades can be achieved. Said design nuances may range from the grey to the black spectrum. Dark brown or beige nuances produce a warm ambiance.

Hereinafter, the invention will be described in more detail, reference being made to possible embodiment examples.

In the drawings:

FIG. 1: shows a perspective illustration of a drive unit with a view on a housing underside of a drive device;

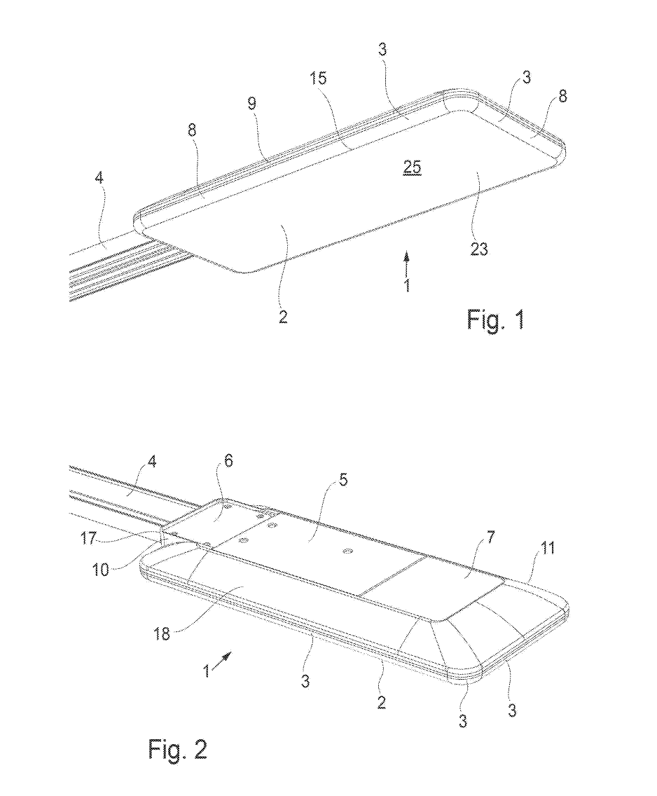

FIG. 2: shows the same as FIG. 1, however with a view on the rear-side area;

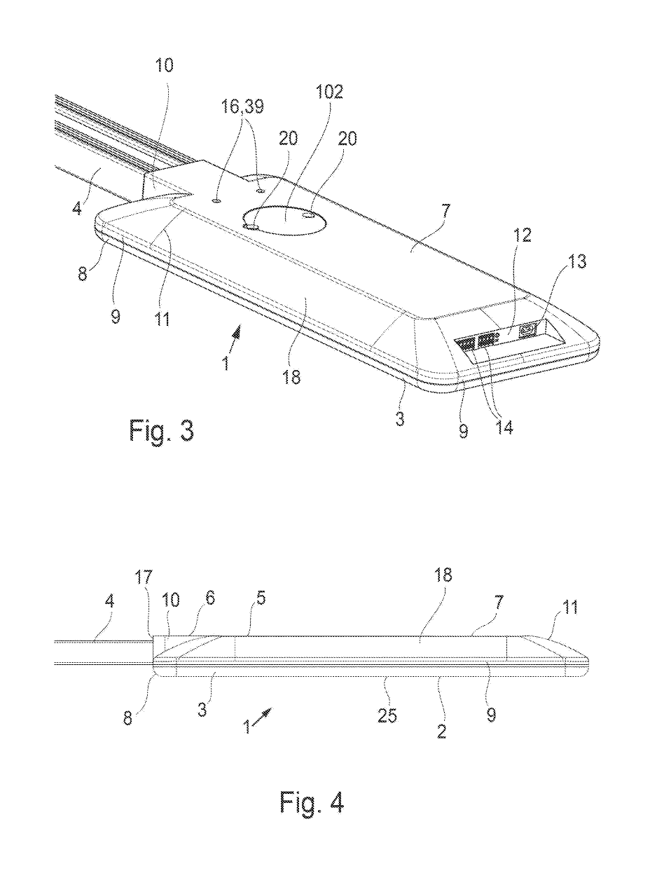

FIG. 3: shows another preferred embodiment of the rear-side area of the drive device;

FIG. 4: shows a lateral view of the drive unit with a connection to a drive track;

FIG. 5: shows a view through the drive device in transverse direction;

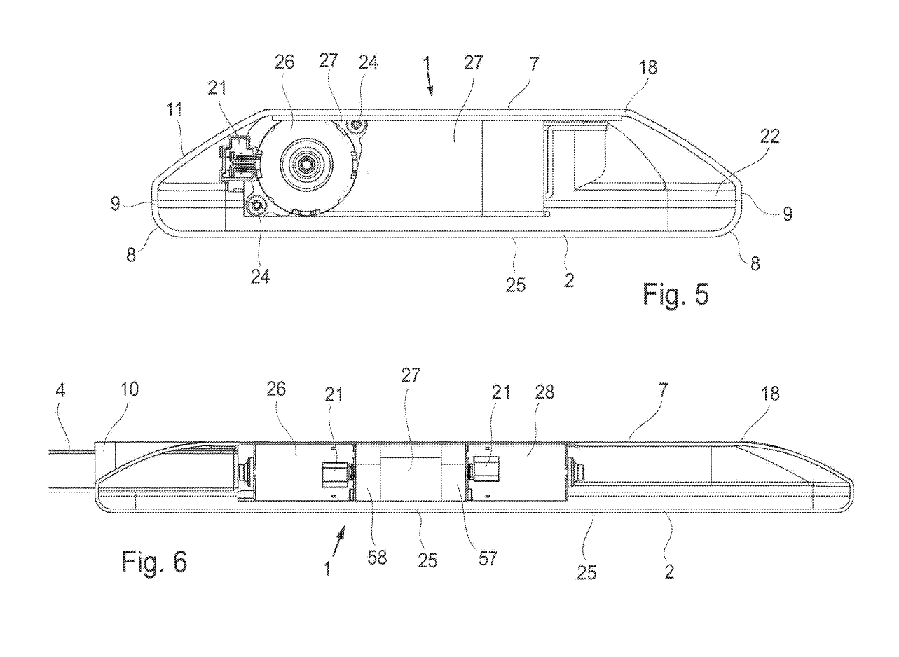

FIG. 6: shows a longitudinal section through the drive device with the drive track;

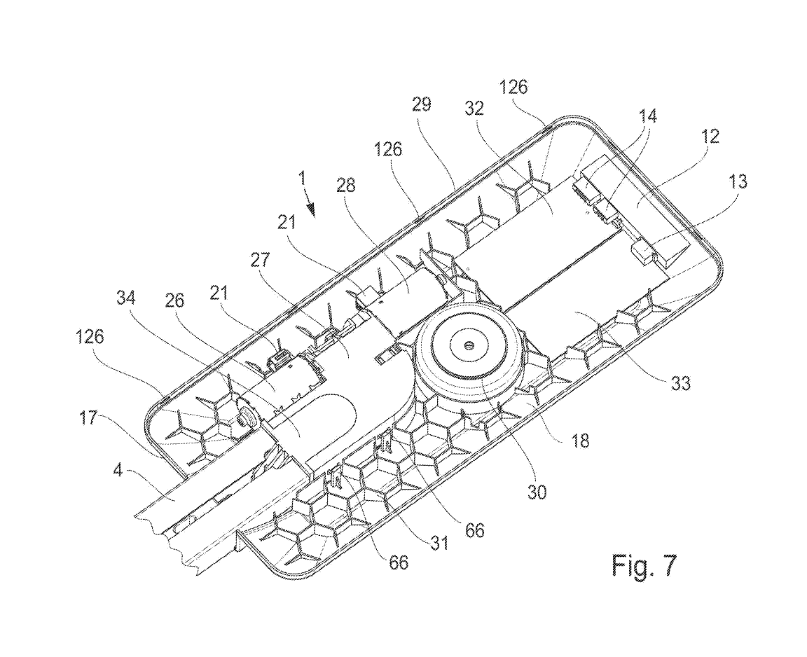

FIG. 7: shows an illustration of an upper housing part of the drive device with the inserted structural components of the drive device;

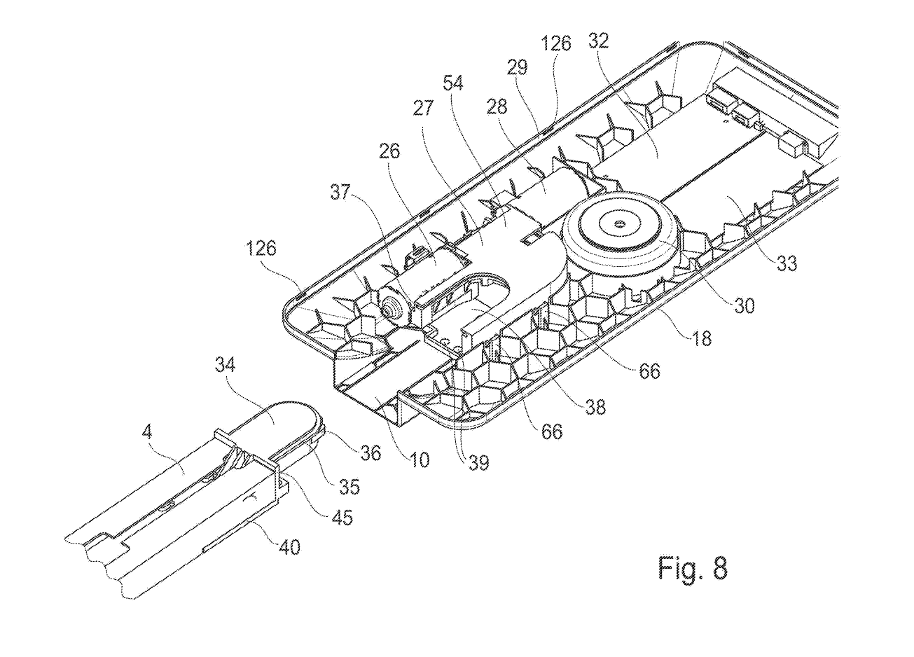

FIG. 8: shows the same as FIG. 7, however with a separation of the drive track;

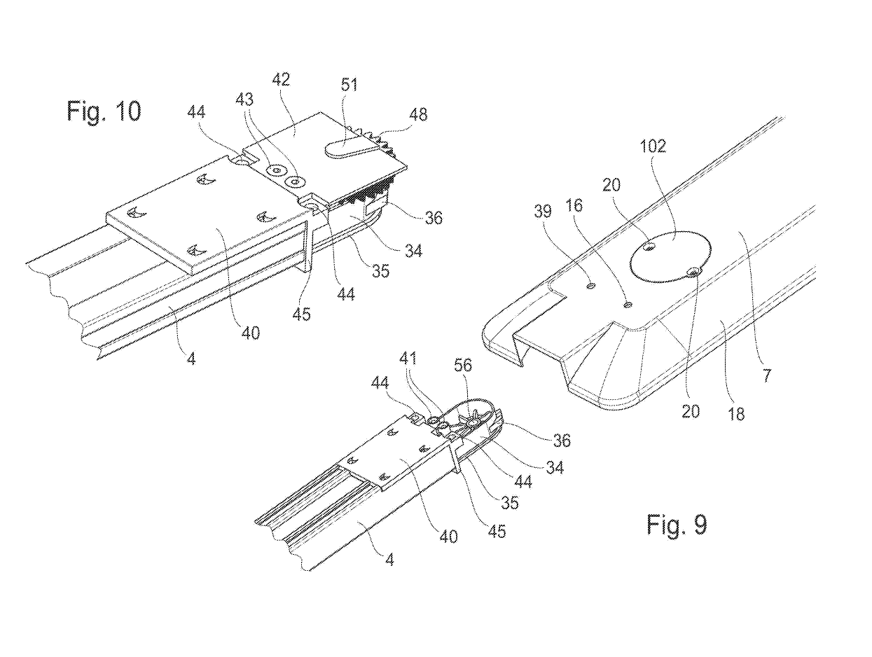

FIG. 9: shows the same as FIG. 8, however, seen from the rear-side view;

FIG. 10: shows an end-side configuration of the drive track with a transmitting part in a first embodiment;

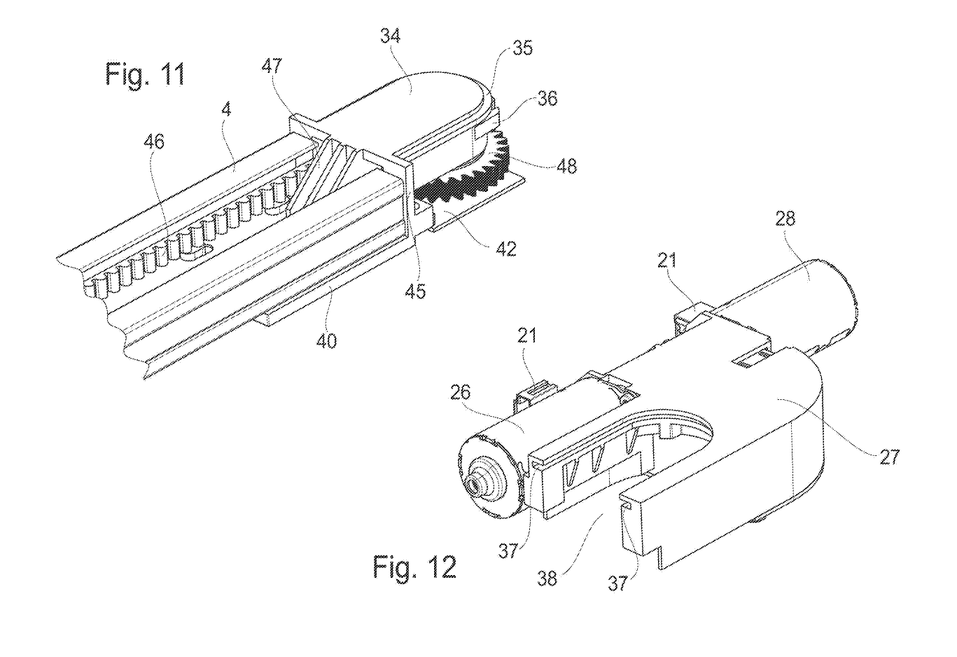

FIG. 11: shows the same as FIG. 10, however while viewing the illustration rotated about 180°;

FIG. 12: shows an embodiment of a gearbox in the embodiment as a driving part with two motors;

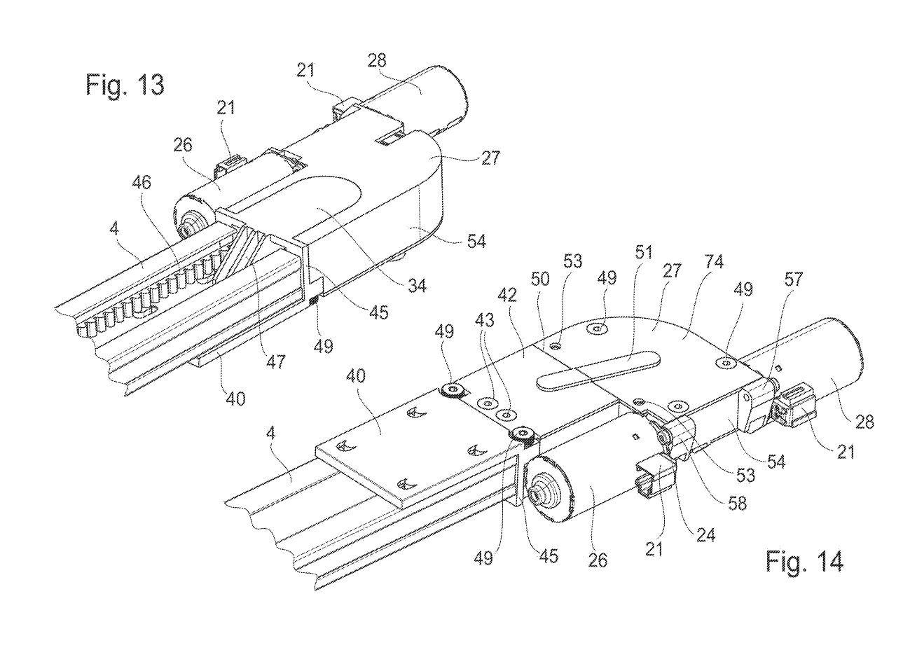

FIG. 13: shows the same as FIG. 12, however, with a connection of the driving part and the transmitting part;

FIG. 14: shows the same as FIG. 13, however while viewing the structure rotated by about 180°;

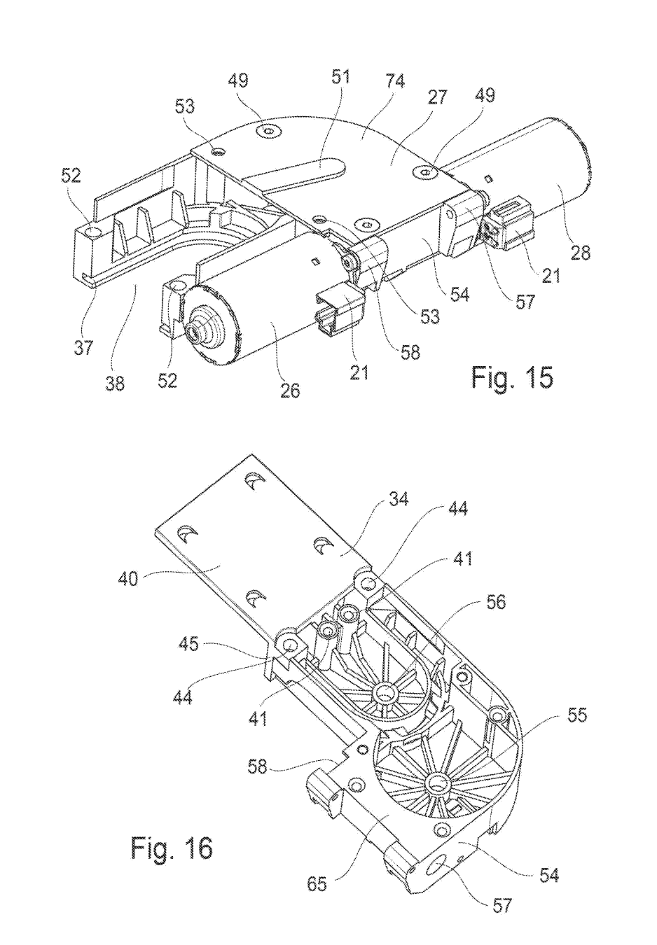

FIG. 15: shows the driving part by itself according to FIG. 12;

FIG. 16: shows the housing configuration of the driving part with the transmitting part;

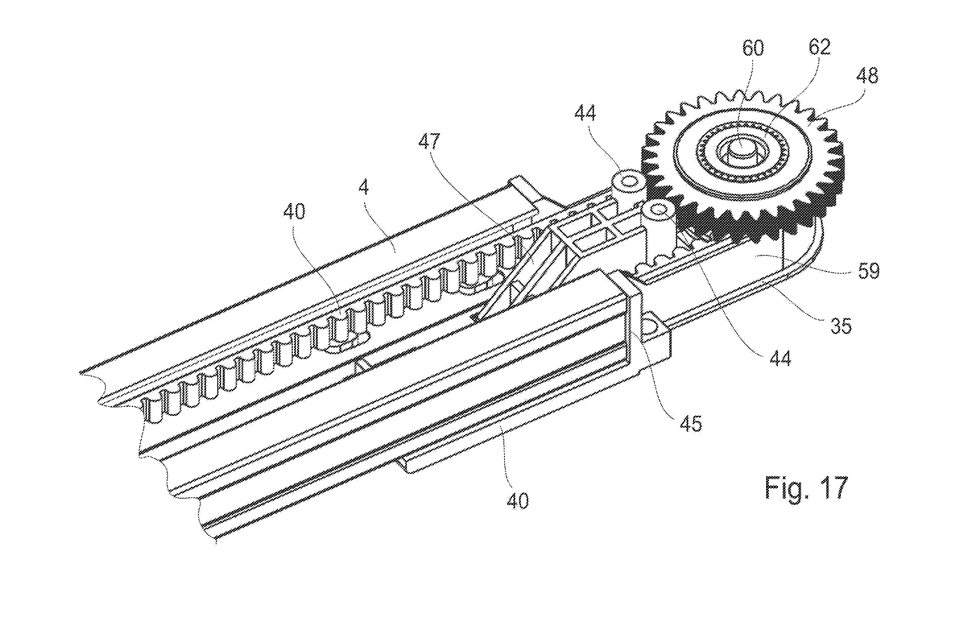

FIG. 17: shows a modified embodiment of a transmitting part;

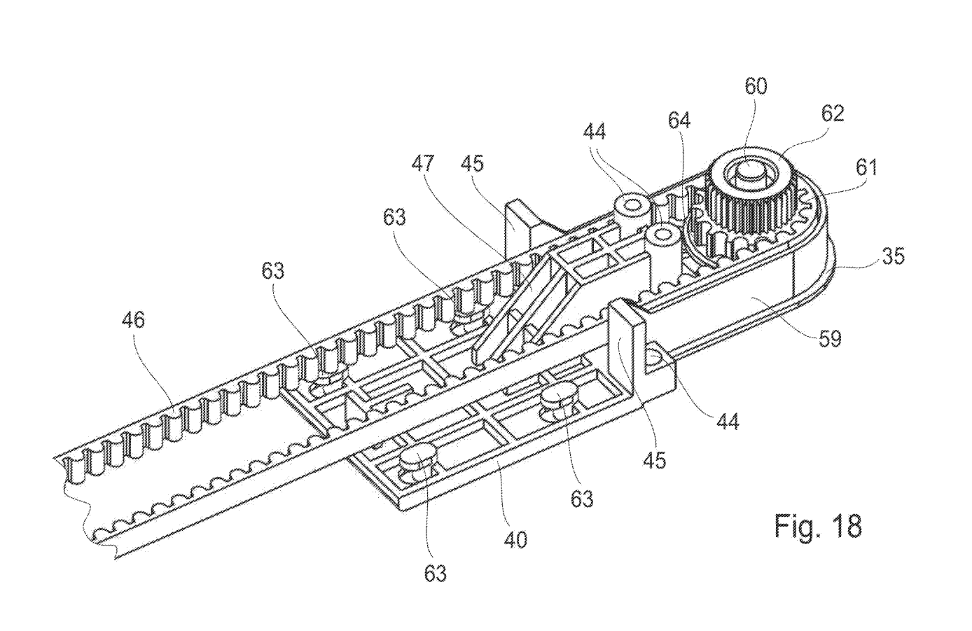

FIG. 18: shows the same as FIG. 17, while omitting a transmitting wheel;

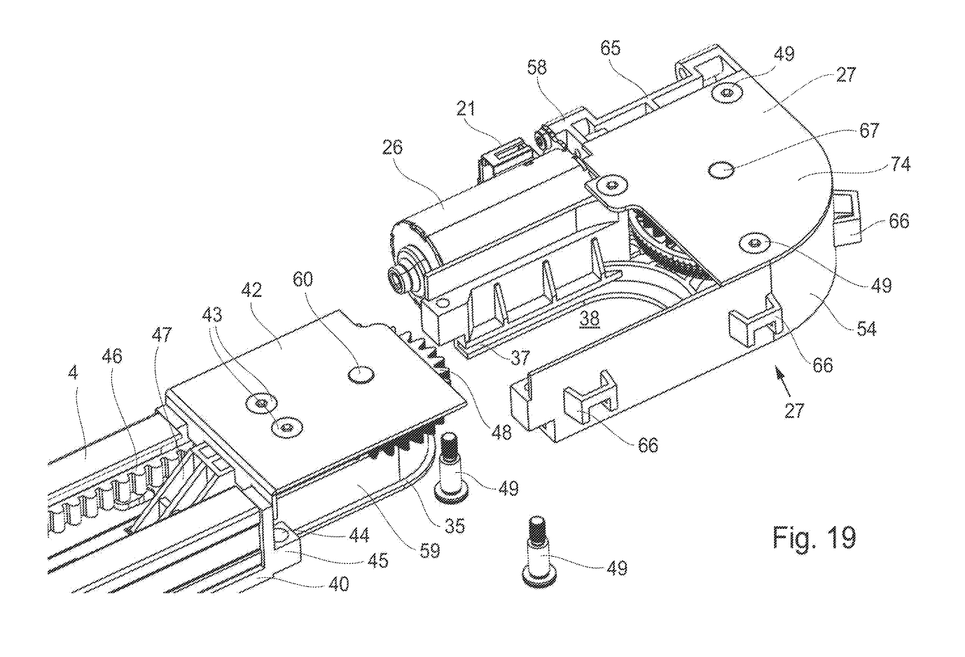

FIG. 19: shows a perspective illustration between driving part and transmitting part;

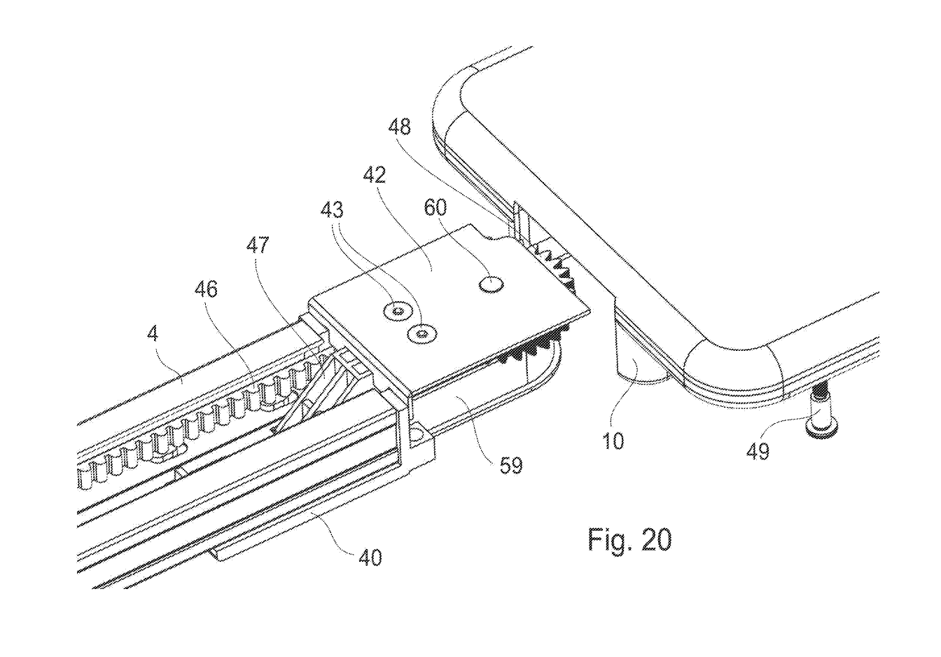

FIG. 20: illustrates the joining between the upper housing part of the drive device and the transmitting part;

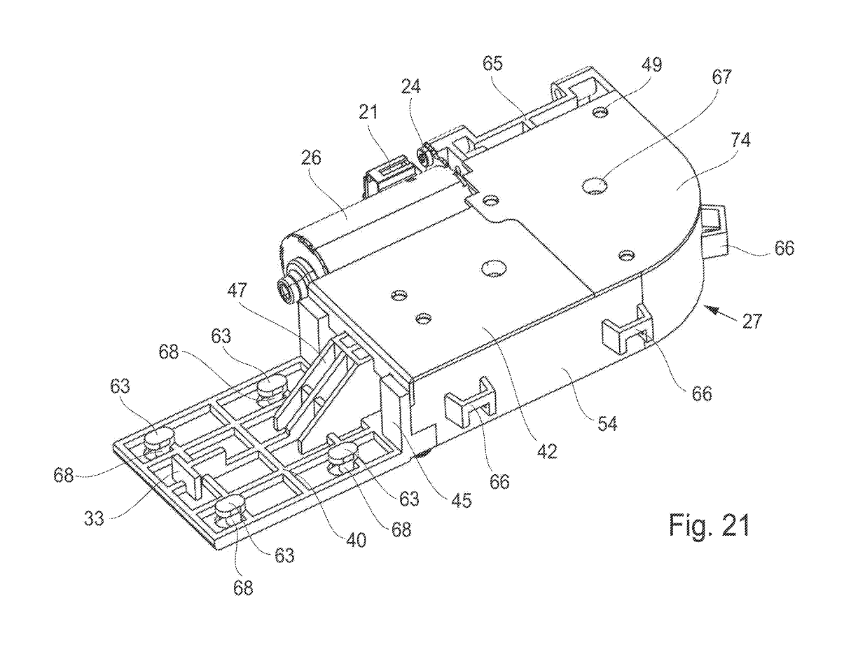

FIG. 21: shows an embodiment of the gearbox with the driving part and the transmitting part while omitting the drive track;

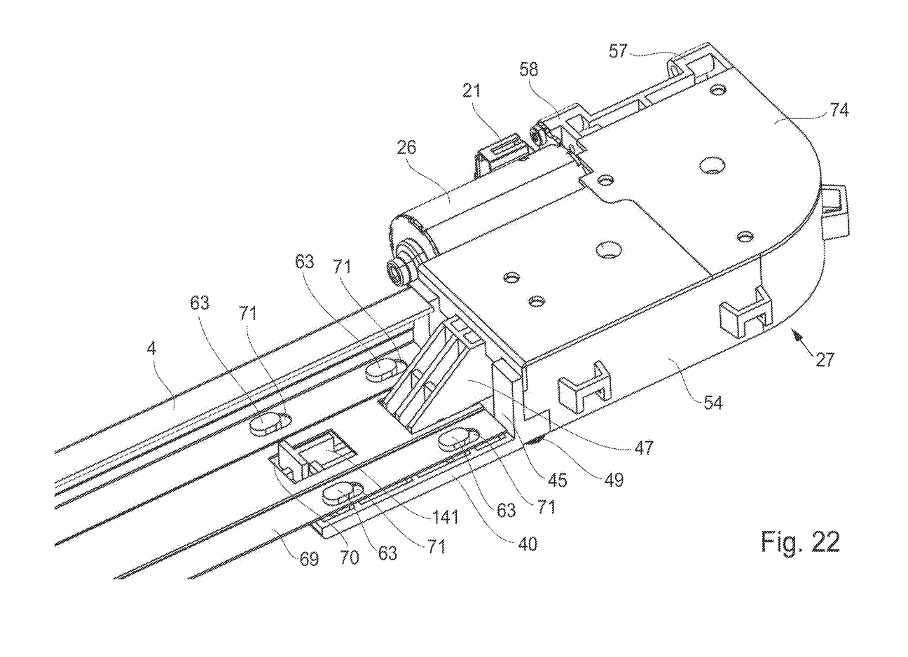

FIG. 22: shows the same as FIG. 21, with a connection to the drive track, which has been illustrated in a partial sectional view;

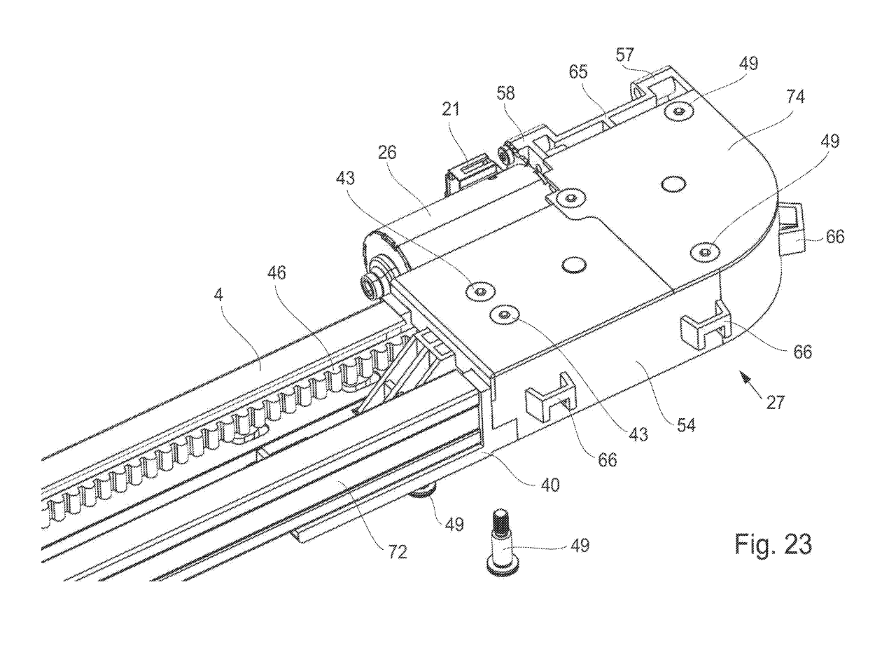

FIG. 23: shows the same as FIG. 22, with a complete drive track;

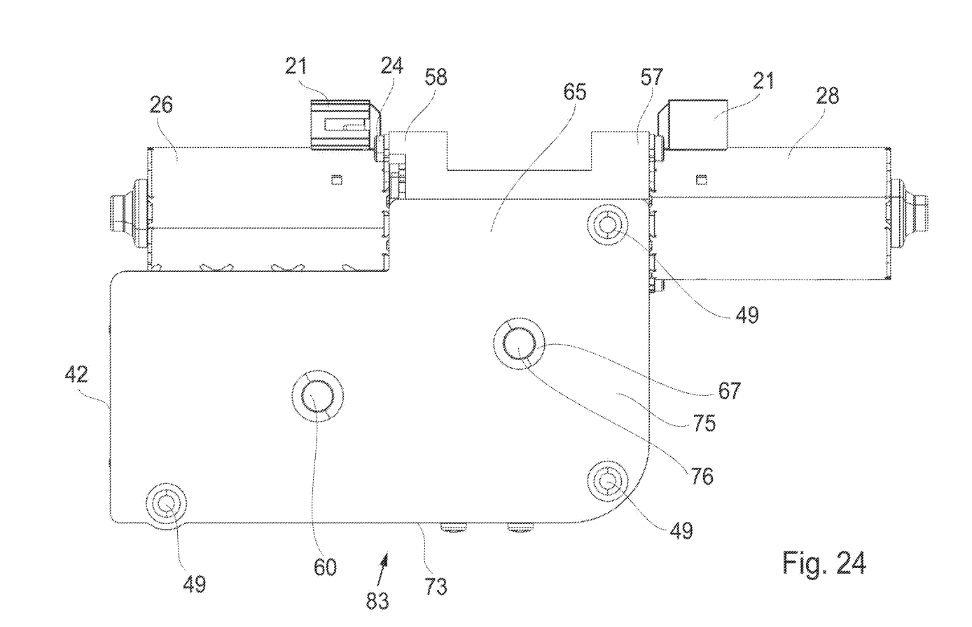

FIG. 24: shows another embodiment of the gearbox with two motors in a top view;

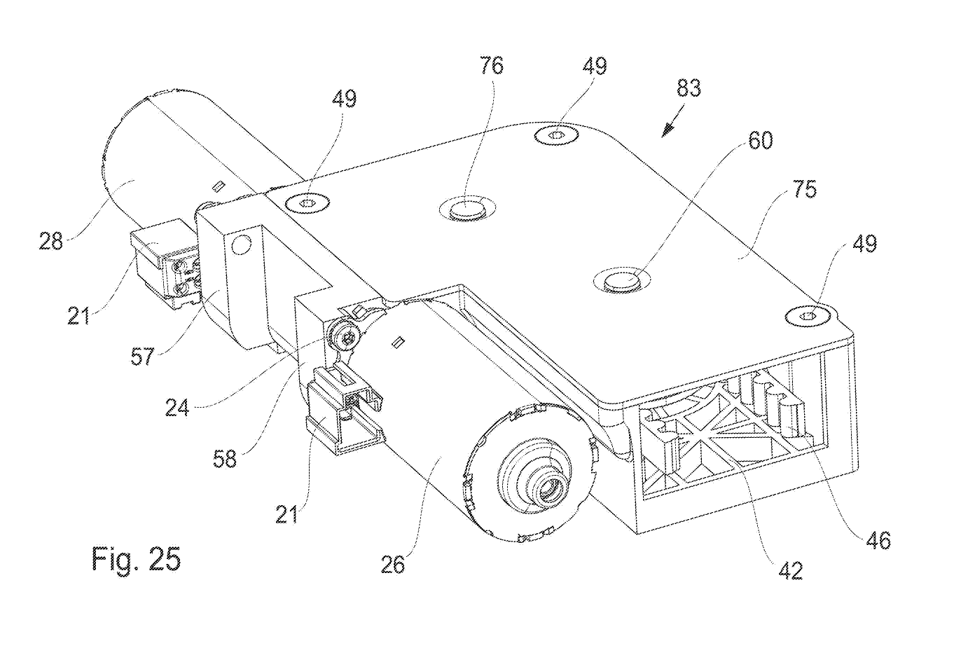

FIG. 25: shows the same as FIG. 24, however in a perspective illustration;

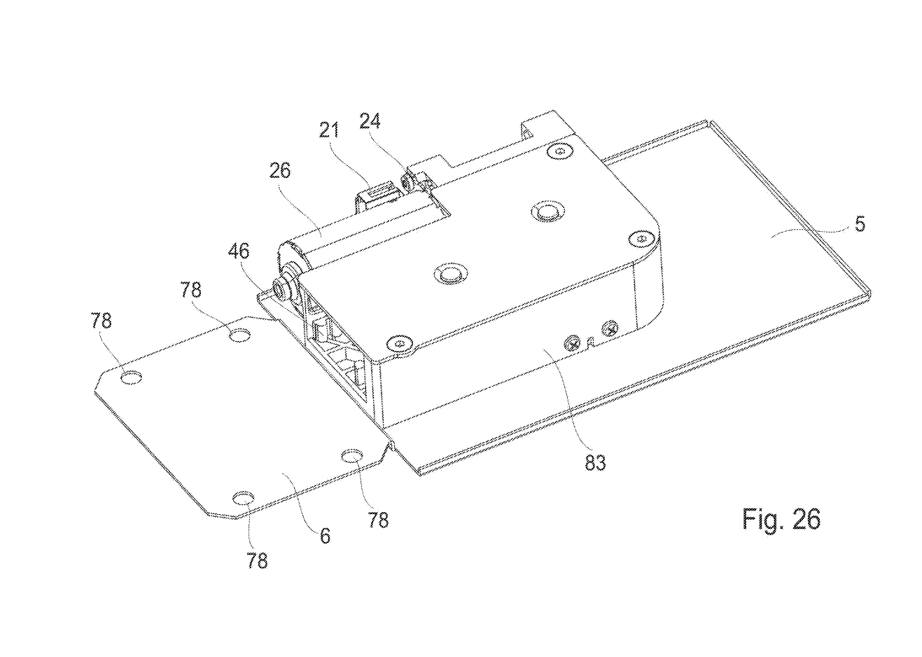

FIG. 26: shows the connection between the gearbox and a mounting base;

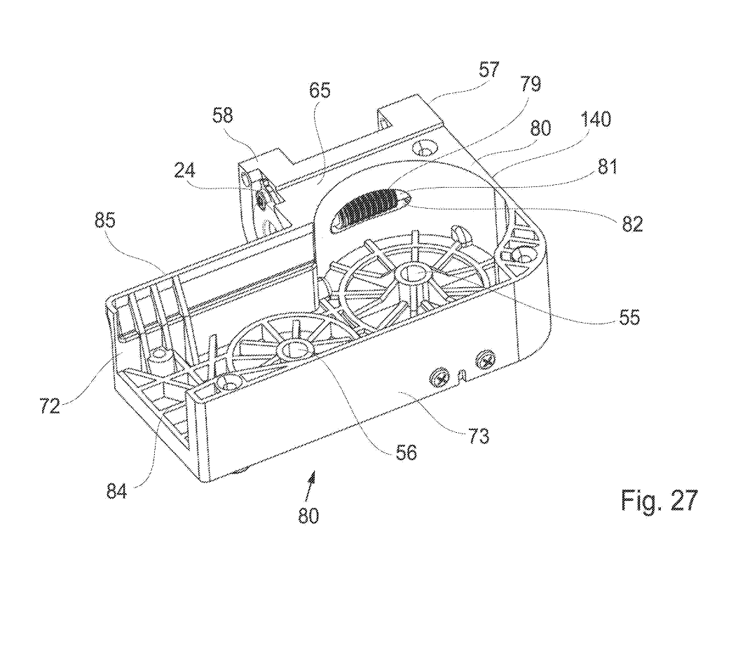

FIG. 27: shows an interior view of the housing of the gearbox;

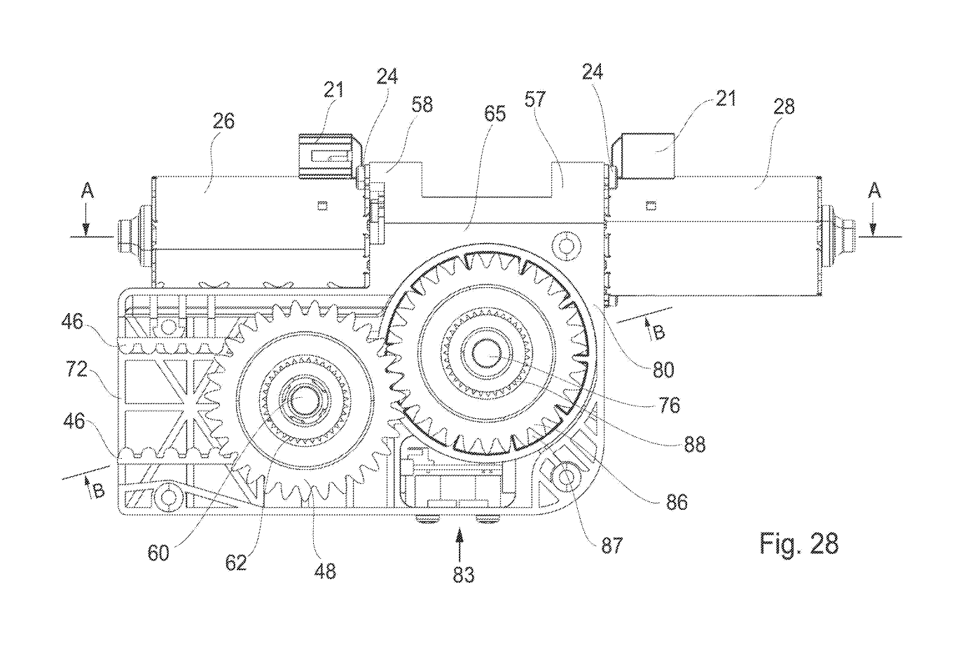

FIG. 28: shows a view on the gearbox without covering;

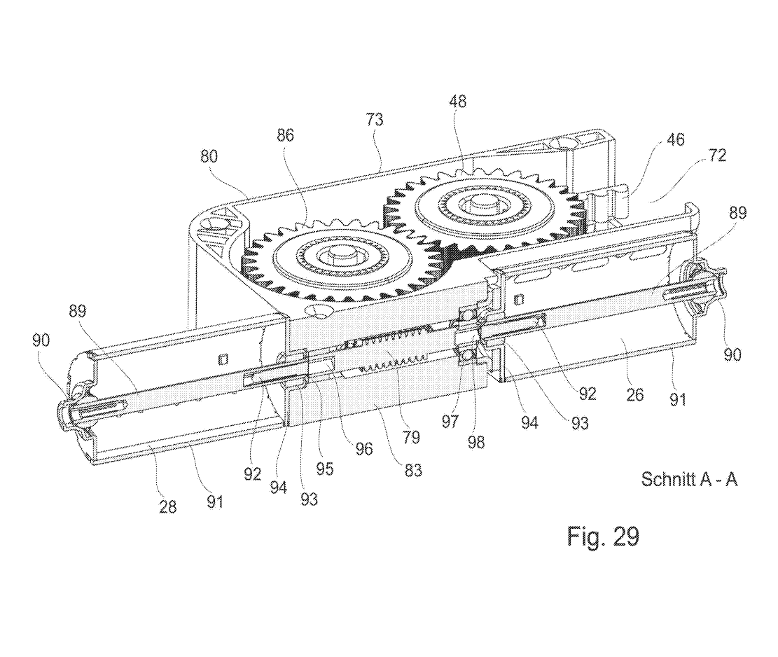

FIG. 29: shows a section A-A through a part of the gearbox according to FIG. 28;

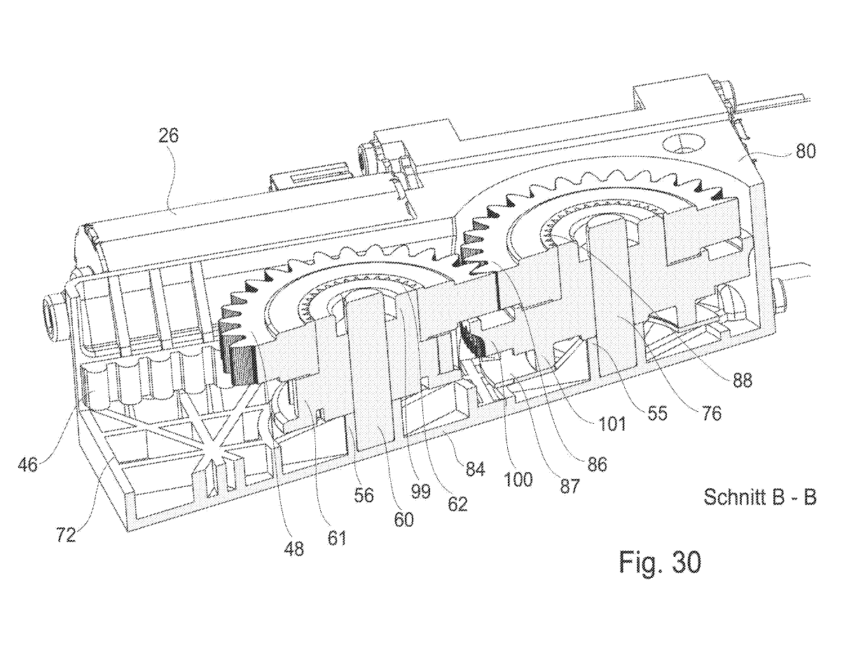

FIG. 30: shows a section B-B according to FIG. 28.

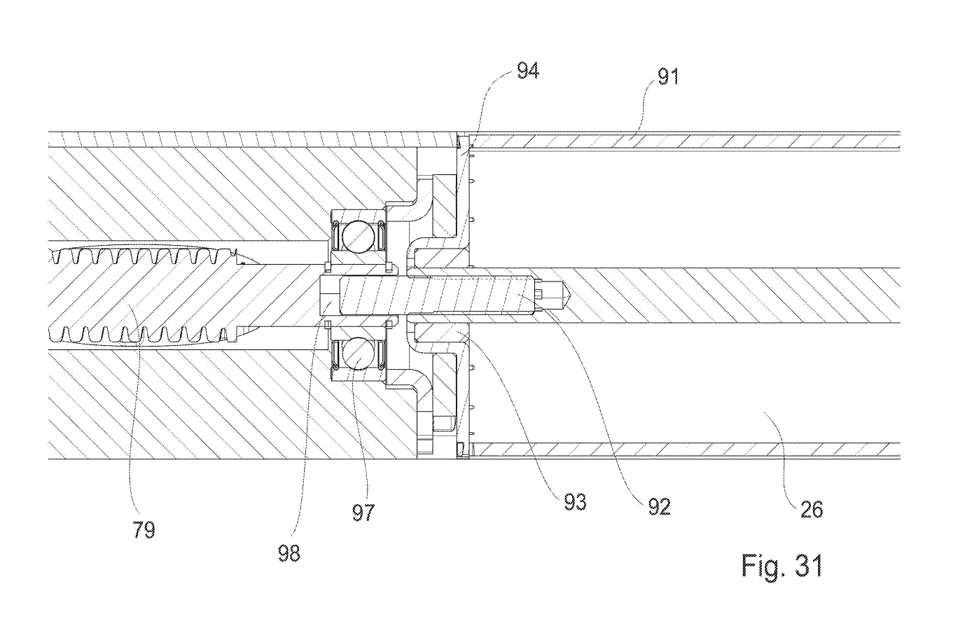

FIG. 31: shows an enlarged illustration between a connection of a worm and a motor according to FIG. 29;

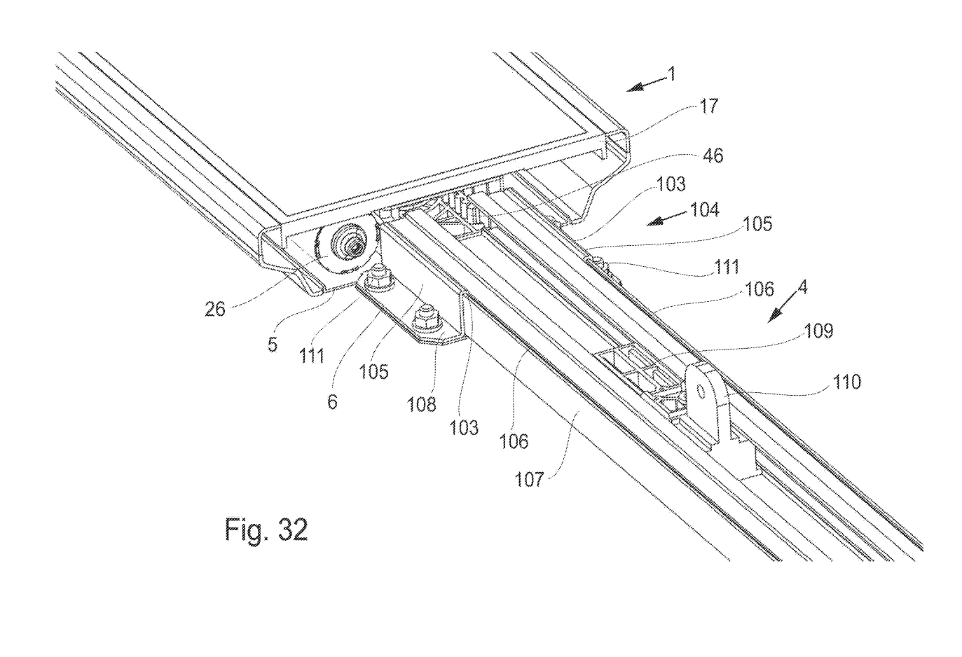

FIG. 32: shows a preferred embodiment of the connection between the drive track and the drive device;

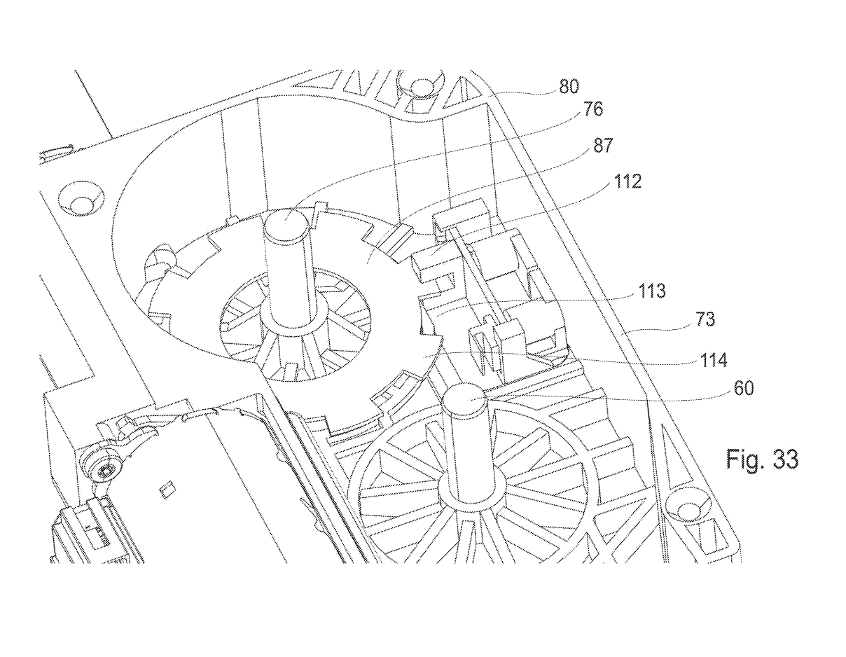

FIG. 33: shows a view into the housing of the gearbox with an arrangement of a measuring device;

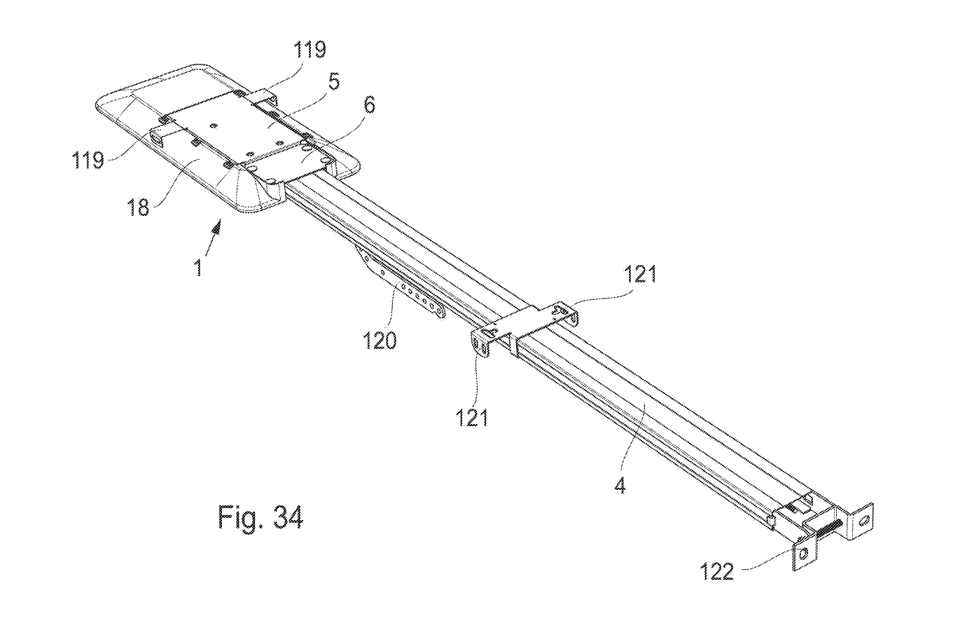

FIG. 34: shows a preferred embodiment of the rear-side configuration of the connection between the drive track and the drive device in a perspective illustration;

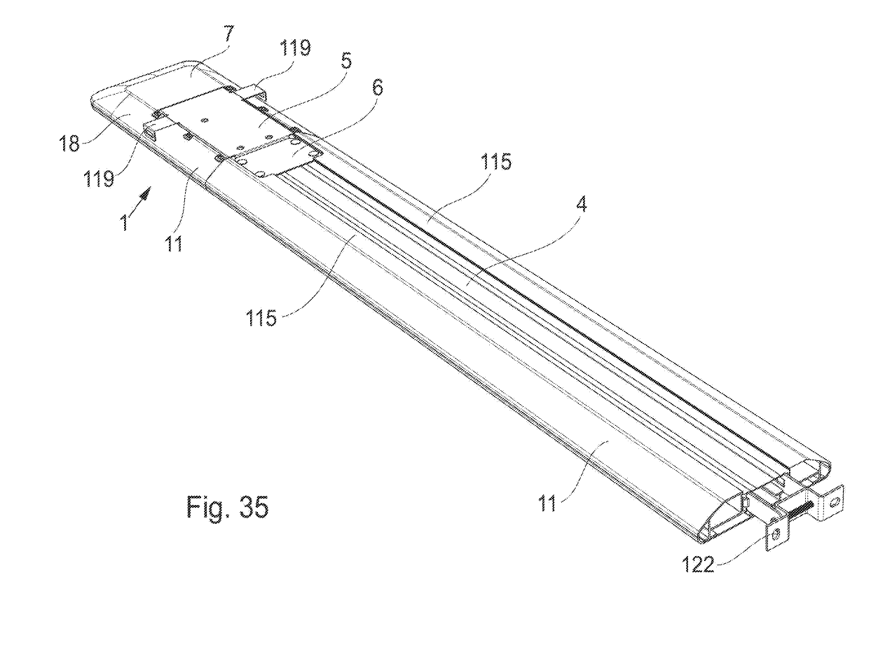

FIG. 35: shows the same as FIG. 34, however with lateral drive track sections;

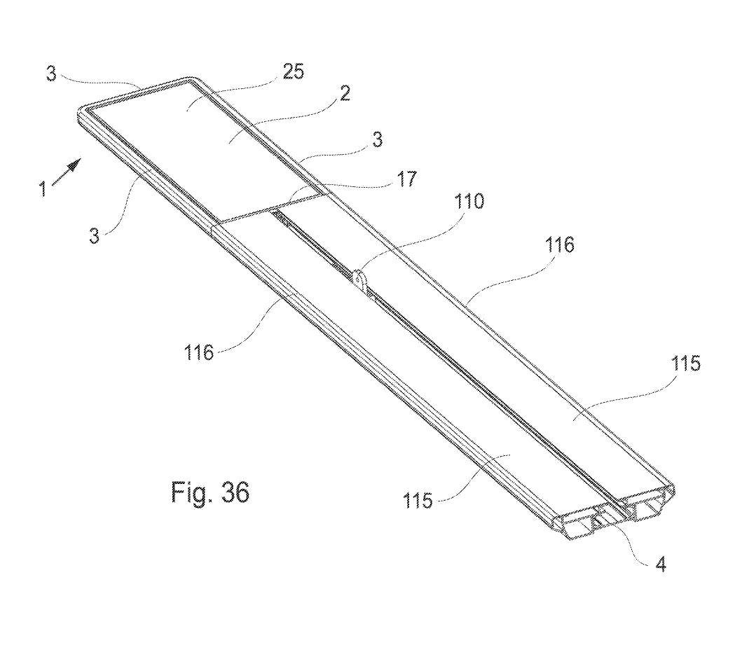

FIG. 36: shows the same as FIG. 25; however with a view on the underside;

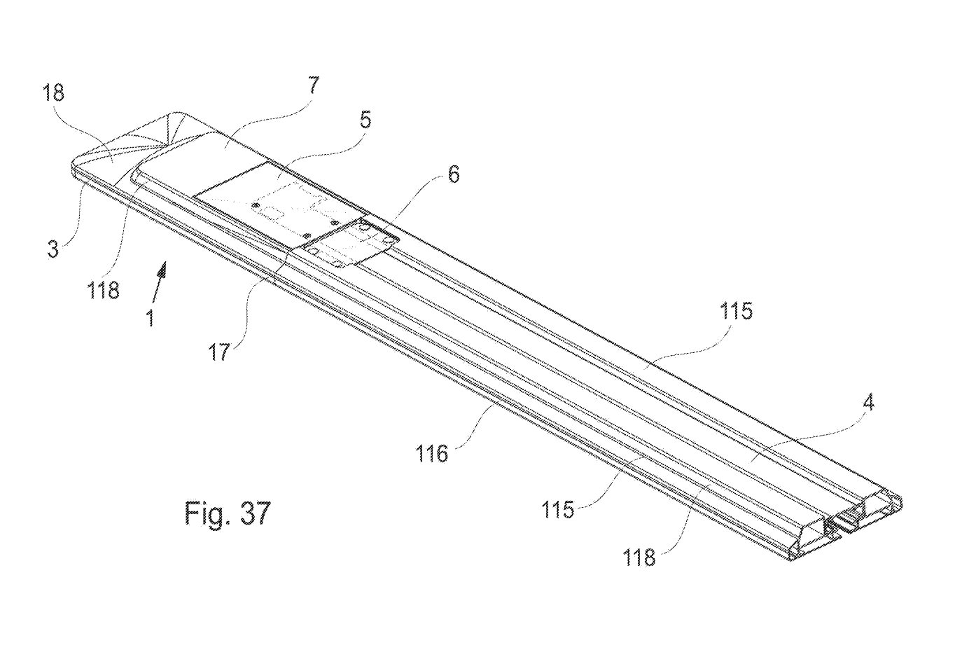

FIG. 37: shows a modified embodiment of the arrangement between the drive device and drive track underside parts according to FIG. 35;

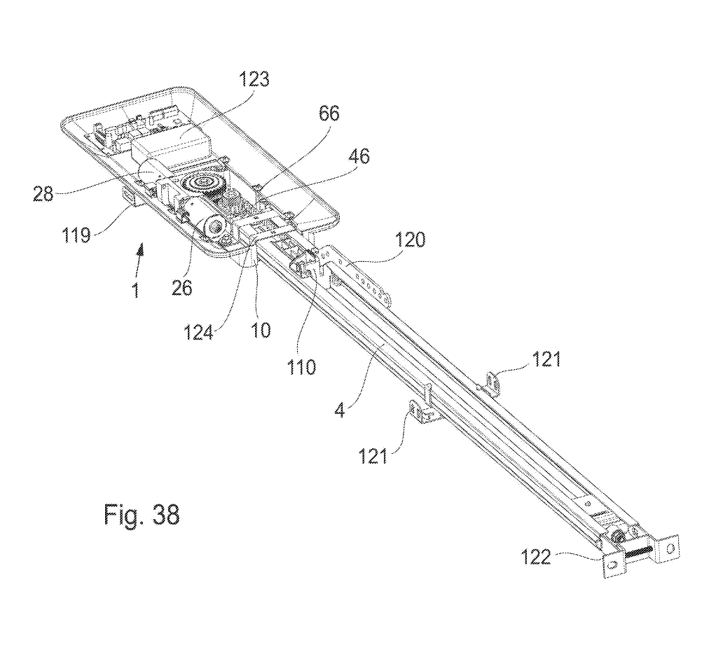

FIG. 38: shows a configuration of the connection between the drive track and drive device while omitting the lower housing part;

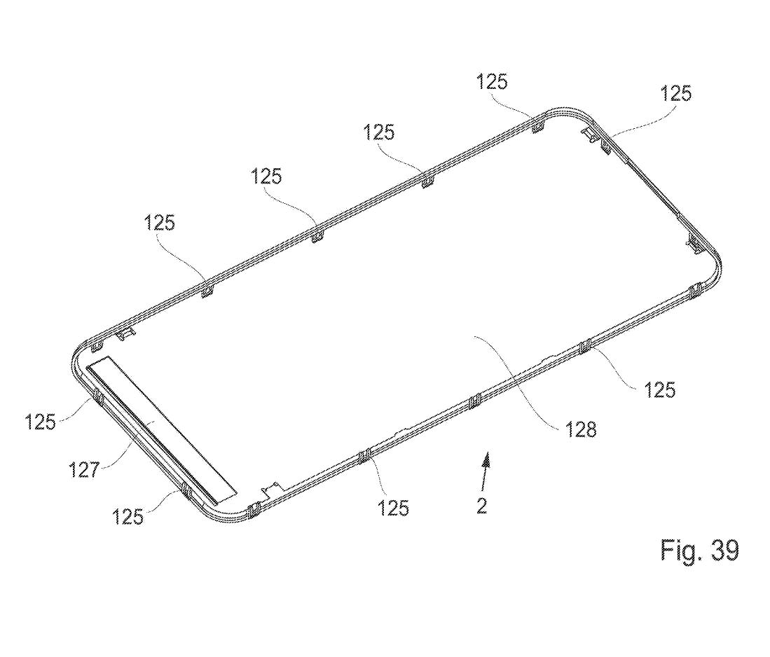

FIG. 39: shows a possible embodiment of the lower housing part;

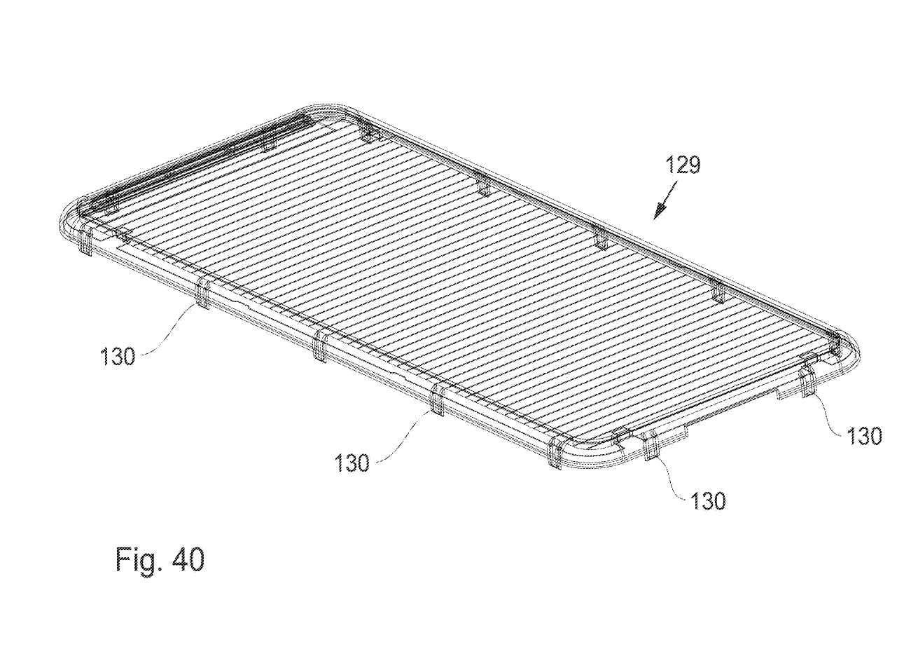

FIG. 40: shows a covering of the lower housing part;

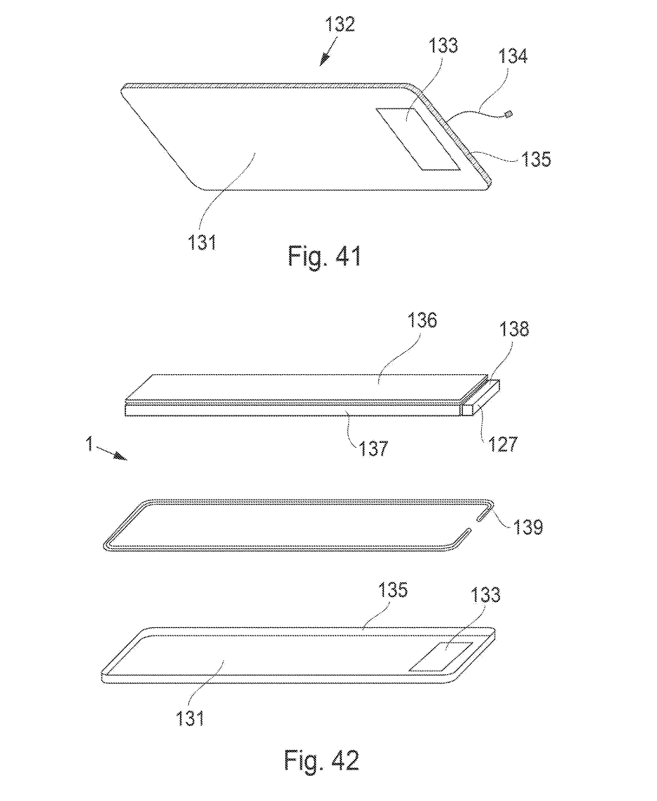

FIG. 41: shows a perspective illustration of an illumination unit;

FIG. 42: shows an exploded drawing with the most important elements of the illumination unit according to FIG. 41.

In a perspective illustration, FIG. 1 represents a drive device 1 in an exemplary arrangement. The drive device 1 includes a straight planar underside 25 of a lower housing part 2. Circumferential roundings 8 laterally adjoin the lower housing part 2, which roundings merge for example into straight lateral sections 9, which are configured to be essentially offset by 90° to the underside 25. FIG. 1 clearly illustrates that the drive device does not include any protruding housing parts. Border areas 15, which surround the underside 25, adjoin the roundings 8 via radii in the corner areas. The area of the roundings 8 may simultaneously also include a light band 3, preferably a circumferential one. Such a light band 3, which is able to effect different lighting designs, which translates into different illumination colours, is achieved by means of control boards 32, 33, which are contained within the drive device 1. A drive track 4 is disposed at a frontal side 17 of the drive unit 1.

FIG. 2 shows an upper housing part 18, which is connected to the lower housing part 2 by means of a plug-in connection. A transitioning area 11, configured in a curved form and extending as far as to the area of a housing upper side 7, may adjoin the lateral sections 9. In this exemplary embodiment, the housing upper side 7 may be configured as well by means of a part of a mounting base 5 with a connected adjoining area 6 for the drive track 4. The form design of the entire housing of the drive device 1 clearly shows that in particular also dominant, respectively protruding housing parts or the like have been foregone for the upper housing part 18, with the intention to reduce manufacturing costs. The adjoining area 6 includes an extension 10, which allows for a connection to the drive track 4 at a frontal side 17 of the drive device 1, without having to configure here any further protruding housing parts, as known from the state-of-the-art.

In the preferred exemplary embodiment according to FIG. 3, the housing upper side 7 does not include any additional structural components, such as the mounting base 5 or the adjoining area 6. In this case, the housing upper side 7 is configured to be straight and, in the area of an arresting member 102, is interrupted by means of attachment bores 16 and 39 as well as attachments 20. Furthermore, the upper housing part 18 is different in that a service access 12 is represented at the frontal side opposite the extension 10.

The service access 12 includes plug-in connections 14 and a mains power supply 13. The service access 12 is closed by means of a non-illustrated removable covering.

FIG. 3 clearly shows once more, that no protruding structural components or the like are located neither at the housing upper side 7 nor at the underside 25. Herein, the housing of the drive device 1 is distinguished by means of a flat, slender housing in a harmonious shape with lateral roundings. The connection of the drive track 4 realized at the frontal side 17 does not interfere with the entire structure of the housing.

FIG. 5 shows a sectional illustration transversely through the drive device 1. In this case, a motor 26 can be seen, which is flanged to a gearbox 27 and is secured by means of a motor attachment 24. An electrical motor connector 21 supplies the motor with electrical energy from the control system 123. The approach and thereby the ingenious incorporation of two motors 26, 28 at the gearbox 27 is again illustrated in the longitudinal section of FIG. 6. In this case, the motor 26 is disposed at a motor connector 58 via the motor attachment 24 and the motor 28 is likewise connected via a separate motor attachment 24 to the gearbox 27 via a motor connector 57.

FIG. 6 reveals the arrangement of the motors 26 and 28, which can be employed selectively or together with the gearbox 27, depending on the power requirements.

FIG. 7 underlines this circumstance, which shows a view into the upper housing part 18, wherein the gearbox 27 with the motors 26 and 28 connected thereto is illustrated in the upper housing part 18. Furthermore, a transformer 30 is provided for the control boards 32 and 33. A cut-out for the ingress of the drive track 4 is located at the frontal side 17 of the upper housing part 18. The gearbox has been immobilized via attachments 66 within the upper housing part 18. In the same manner, the other structural components have been also clipped into the assigned areas of the upper housing part 18. This type of mounting, as well as the placement of the structural components, can be seen in FIG. 8. Unlike FIG. 7, the drive track 4 is not connected. At the head side, the drive track 5 comprises a transmitting part with a linking part 34, which part has been separated from the part, referred to as the driving part, of the gearbox 27. The linking part 34 includes a linking plate 40, which serves for the direct connection to the drive track 4. By means of guiding webs 35, a precise-fitting placement of the transmitting part in the gearbox 27 is realized via a linking part reception 38. The guiding webs 35 are pushed into guiding receptions 37. The proper seating of the transmitting part may also be additionally assisted by means of at least one projection 36 provided at the linking part 34, which projection engages into a complementary recess within the gearbox housing.

FIG. 9, which illustrates a rotation by 180° of both the drive track 4 and the upper housing part 18, reveals that the linking part 34 also includes attachment bores 44 as well as 41. It is via the bores 44 that a fixation of the transmitting part within the drive device 1 is furthermore assisted in conjunction with the bores 16, 39 within the housing upper side 7. In this case, the linking part 34 has been manufactured as a moulded part, for example made from plastic material or from metal, and includes an axis reception 56.

In FIG. 10, an axis 60 has been inserted into the axis reception 56, and likewise a drive wheel 61 for a force transmitting means 46, as well as transmitting wheel 48 which are likewise located above the axis 60. A covering 42 covers a portion of the transmitting wheel 48, wherein also an axis bearing for the axis 60 is provided at the end side within the covering 42. The covering 42 is attached via screw connections 43, which penetrate into the attachment points 41 located there below.

While in FIG. 10 the view is directed to the underside of the drive track 4, in FIG. 11, the same embodiment is represented, just in a view onto the opening side of the drive track 4, in which Figure also the force transmitting means 46 are revealed. This illustration reveals that the end of the drive track 4 abuts against an abutment web 45 of the linking part 34. Furthermore, struts 47 are illustrated within the drive track 4 for stabilizing the linking part 34.

FIG. 12 shows a gearbox 27, to which two motors 26, 28 are flanged. Furthermore, this illustration very clearly reveals the configuration of the linking part reception 38 within the gearbox. FIG. 13 represents how the transmitting part with the linking part 34 is located within the configuration of the linking part reception 38 and how the drive track 4 disposed thereat is located within the gearbox 27. The linking part 34 is connected to the gearbox housing 54 via the connecting screws 49. This configuration is likewise revealed in the illustration according to FIG. 14, in which the drive track 4 with the gearbox 27 and the motors 26, 28 have performed a rotation about 180°. The covering 42 meets a top cover 74 of the rest of the housing, wherein a parting line 50 is created in order to be able to realize a simple mounting of the driving part to and dismounting from the transmitting part. So that a precise fitting alignment is possible when joining the driving part and the transmitting part, a projection 51 is provided both in the area of the covering 42 and of the top cover 74. So that in addition to the attachments 66 represented in FIG. 7 further attachments of the gearbox 27 can be embodied, attachment bores 53 are contained within the gearbox 27, through which the connecting elements pass, which are inserted into the attachments 20. Subsequently, a covering 102 is employed to be placed onto the projections 51 and to be simultaneously immobilized at the housing upper side 7 by means of the attachments 20 in conjunction with the attachment bores 53.

FIG. 15 represents once more the arrangement of the driving part of the gearbox 27 in an individual illustration. Herein, the linking part reception 38 with the guiding receptions 37 can be seen. The motors 26 and 28 are disposed at the motor connectors 57 and 56, which are conformed to the gearbox housing 54. The two motors 26, 28 are supplied each with electrical energy from the control system 123 via the respective electrical motor connectors 21.

FIG. 16 shows the gearbox housing 54 in conjunction with the linking plate 40 for the drive track 4. It is revealed herein that the axis receptions 55 and 56 are conformed into the bottom 129 of the gearbox housing 54.

Another preferred embodiment of the configuration of the transmitting part is represented in FIG. 17. In this case, the configuration of the connecting part 59 is represented in a modified embodiment. A spur gearing 32, which serves for supporting the transmitting wheel 48, is located on the axis 6. If the transmitting wheel 48 and the drive track 4 are removed, the illustration of FIG. 18 represents a view onto the redirection roller in the shape of a driving wheel 61. In this case, the force transmitting means 46 is wrapped around the driving wheel 61. The connecting part 59 is configured in that it includes the area for connecting to the gearbox 27 and moreover also contains the linking plate 40 for connecting to the drive track 4. In this case, projecting attachments 18, which, when joining with the drive track 4, guarantee a proper seating with the linking plate 40, are provided at the linking plate 40. In this case, the drive track 4 abuts against locating webs 45 at the end-side, in which also the bores 44 are contained.

The operation of joining the transmitting part to the drive track 4 and the driving part to the gearbox 27 is represented in FIG. 19. By placing the connecting part 59 into the linking part reception 38, the cooperation of the transmitting wheel 48 with the driving wheel 86 is illustrated. The gearbox 27 is inserted into the upper housing part 18 through the exterior attachments 66 and immobilized. Also this configuration of the transmitting part allows for inserting the drive device 1 without any problem into the extension 10 of the housing, as can be seen in FIG. 20.

The illustration of FIG. 21 represents the cooperation of the linking plate 40 with the gearbox 27 in a separate embodiment. In this exemplary embodiment, only one motor 26 has been flanged via the motor attachment 24. Hereby, the locating webs 45 reach abutment at the exit side 72 of the gearbox 27. The holding elements 63, which are configured to protrude and include an undercut 68, are represented within the linking plate 40. FIG. 22 represents the manner, in which the holding elements 63 engage into the section-wise illustrated through-openings 71. In this case, the illustrated holding elements 63 are inserted into the through-openings 71 and are displaced into the direction of the locating web 45. With the intention to achieve a precise-fitting positioning of the drive track 4, on the one hand a projection 141 is provided within a through-opening 70, and on the other hand, the strut 47 is provided in a further cut-out for stabilizing the position. The holding projections 63, which, after having placed the drive track 4, simultaneously reach an interlocking position following the displacement in the direction of the locating web 45, engage on each side into the through-openings 71, which are configured as oblong holes. Thereby, the oblong holes 71 together with the holding elements 63 produce a non-positive and positive connection between the linking plate 40 and the drive track 4. This arrangement is illustrated in FIG. 23 in a complete illustration of the embodiment of the drive track 4.

FIG. 24 represents a modified embodiment of a gearbox 83. In this case, the connection of the motors 28 and 26 is maintained in the above-described manner via the motor connectors 57 and 58. The gearbox 83 has a frontal-side exit 72 and presents an essentially rectangular shape, which is characterized by a sidewall 73 and on the opposite side by the extension 65. The extension 65 is located in the area of the motor connectors 57, 58 and includes the bearing of a worm 79 in the already described manner. The gearbox 83 is closed by means of connecting screws 49, wherein axes bearings for the axis 60 and an axis 76 are provided within the top cover 75 thereof.

The perspective illustration according to FIG. 24 reveals the connecting side 72 of the gearbox 83. It is via the connecting side 72, that the force transmitting means 46 is introduced into the gearbox 83 and redirected therein and again led to the outside.

The gearbox 83 illustrated in the FIGS. 25 and 26, is illustrated according to FIG. 26 as being attached to the mounting base 5. An adjoining area 6, in which the bores 78 are provided, which serve for the attachment to the drive track 4, is illustrated on one side at the mounting base 5. A drive housing 80, which is configured for the gearbox 83, is represented in FIG. 27. In this case, starting at the base bottom 84, which on the exterior has a smooth straight configuration, sidewalls 85 and 73 are provided. A frontal wall 140 is provided opposite the open exit side 72. The worm 79 is illustrated in the extension 65 via worm bearings 81. An opening 82, through which the teeth system of the worm 79 passes for reaching an operative connection with a worm wheel 110, is provided in the range of the worm 79. In the sectional illustration B-B according to FIG. 30, the cooperation of the structural gearbox components is revealed. The worm wheel 100 is supported on the axis 76 and, via an extension, includes a spur gearing 88, on which the driving wheel 86 is seated. The transmitting wheel 48, which is supported on the axis 60, is in operative connection with the driving wheel 86. Via the spur gearing 62, the driving wheel 61 for the force transmitting means 46 is located below the transmitting wheel 48. As can be seen furthermore in this illustration, the axis 76 and 60, in the shape of spindle inserts, are inserted into the base bottom 83 of the housing.

In a view onto the gearbox 83 without the covering according to FIG. 28, this arrangement is once more revealed. In this case, the driving wheel 86 is larger than the transmitting wheel 48; however, this can be configured differently according to the embodiment.

In the sectional illustration A-A according to FIG. 29, in particular the bearing of the worm 79 can be seen on the left side via an end-side bearing 93, which is configured as an axis reception and includes a spindle insert 90, which is connected to the rotor axis 90 of the motor 28. A ball bearing 97 is illustrated on the right side. Another spindle insert 96 engages into an axis reception 97 and is connected to the rotor axis 89 of the motor 26. At the end sides, the rotor axes 89 are supported in the motors 26, 28 in motor extensions of the motor housing 91. This arrangement can be seen once more in a detailed illustration of FIG. 31. The end of the worm 79 includes an axis reception 98, into which the spindle insert 92 engages on one side. In this case, the axis reception is supported within a bearing 97. Moreover, the spindle insert 92 is supported in a rotor bearing 93.

The perspective illustration according to FIG. 32 represents a portion of the drive device 1 and, at the frontal side 17, the connection to the drive track 4 via attachment means. The motor 26 is visible within the drive device 1. The force transmitting means 46 is guided within the drive track 4 and is redirected within the gearbox 83 via the driving wheel 61. A carriage 109, which is connected to a catch element 110 and displaceably supported within the drive track 4, is in operational connection with the force transmitting means 46. An arm assembly 120 is linked via the catch element 110. In this exemplary embodiment, the mounting base 5 is extended by an adjoining area 6. With the intention to achieve an attachment of the drive track 4 to the adjoining area 6, attachment means 105 are mounted laterally to the sidewalls 107 of the drive track 4. In the exemplary embodiment, the attachment means 105 are configured as angularly-shaped brackets, which include a base branch 108 and adjoined thereto a distancing branch. At the end of the distancing branch, a retaining claw 103 is provided, which overlaps the drive track 4 at least partially. This may be configured for example in that the retaining claw 103 engages into a groove 106 of the drive track 4. The attaching means 105 are immobilized at the adjoining area 6 via the attachments 111. In this case, the attachments 111 are embodied as screws. Thus, pre-mounting in the factory is possible, namely in that the attachment means 105 can be already pre-mounted. At the construction site, it is thereby possible to push the ends of the drive track 4 between the lateral attachment means 105. This illustration reveals as well that the drive track 4 is placed at the frontal side 17 of the drive device 1.

In a particular embodiment, the gearbox systems 27 and 83 may be equipped with a measuring device for counting the revolutions. For this purpose, FIG. 33 represents one possible example, in which a measuring wheel 87 is employed, which is connected to the worm wheel. In this case, the measuring wheel 87 includes projections 114 next to gaps 113. Such a measuring device consists for example of an incremental encoder, which counts the revolutions based on the different increments. Counting said increments is performed by means of a light barrier 112. In addition to said preferred embodiment, it is possible to embody other configurations of a measuring device as well, in particular using hall generators and rotating magnets.

The connection of the drive device 1 to the drive track 4, both to the casing area and to a ceiling or the like, can be seen in FIG. 34. In this case, in the casing area, an attachment 122 has been used, which is able to perform a rotational movement for compensating tolerances. The drive track 4 has a suspension 121, which by means of hanging means allows for building a precise fitting suspension and alignment of the entire structure. The same applies to the suspension 119, which is configured in the exemplary embodiment at the mounting base 5.

The drive device 1 described in the different embodiments may experience a further improvement by means of the light band 3 at the border area of the housing. In a preferred embodiment, it is possible to additionally enlarge, respectively to complete the drive track 4 with lateral drive track lateral parts 115. So to say in continuing the exemplary embodiment of the light band 3, said drive track lateral parts 115 may be embodied on each side by means of a light band 116.

FIG. 35 shows the embodiment of FIG. 36 from the backside and reveals that the design of the drive track lateral parts 115 is realized in continuation of the design of the drive unit 1. In a modified form, it is possible that, with a larger space requirement within the drive device 1, the upper housing part 18 is provided with an extension 118. Said extension 118 retracts with regard to the exterior edges and likewise continues as an extension 118 into the area of the drive track lateral parts 115.

FIG. 38 is intended to reveal that the drive track 4 can be also accommodated in a different way within the drive housing and attached by means of attachments 124. In this case, the drive track 4 enters the upper housing part 18 via the extension 10.

In a particular embodiment, the lower housing part 2 may be configured in that it simultaneously serves as an illumination apparatus. In this case, connecting receptions 126 can be formed for example into a border 29 of the upper housing part 18, which receptions cooperate with connecting projections 125 of an illumination unit 132, and may consist for example of a flat straight bottom 128, at which the lateral connecting projections 125 are disposed. A radiation unit 127 for emitting light rays is provided at least at one side. In this case, preferably the entire bottom 128 may be provided with a light-enforcing respectively light-reflecting coating or the like. The radiation unit 127 is supplied with electrical energy by means of the control system 123 of the drive device 1. The exterior termination may be formed for example by a covering 129 according to FIG. 40. The latter is connected to the lower housing part 2 by means of said projections 130 and is removable.

A particular embodiment of the illumination unit 132 may be seen in FIGS. 41, 42. The illumination unit 132 is illustrated in a perspective illustration with a straight planar radiation surface 131. A communications field 133 is illustrated within the radiation surface 131. The radiation surface 131 is delimited by a lateral edge 135. Electrical energy is supplied from the control system 123 to the illumination unit 132 via an electric connection 134. In addition to displays, the communications field 133 may include electronic touch fields.

The basic structure of the illumination unit 132 is represented in an exploded illustration in FIG. 42. In the lower part of the illustration, the radiation surface 131 is illustrated with a lateral circumferential border 135. The communications field 133 is illustrated within the radiation surface 131. In a preferred embodiment, it is possible that a reflector be provided behind the radiation surface 131. Said reflector 136 is terminated by means of a circumferential frame 137. Laterally at the frame 137, at least one radiation unit 127 may be affixed, in which the light-emitting diodes are accommodated. By supplying electrical voltage, said non-illustrated light-emitting diodes generate light, which effects a homogenous lighting of the radiation surface 131 by means of the configured reflector 136.

In a further preferred embodiment, it is possible to insert a light guide 139 behind the border 135 of the radiation surface 131. Said light guide 139 may be charged with electric voltage from the radiation unit 127. However, it is likewise possible to employ here an additional radiation unit 138. The light guide 139 is just located in the exterior area of the border 135, wherein the border 135, just like the entire radiation surface 131, may be transparent, respectively made from a translucent plastic material. When the light guide 139 is energized, light is emitted. The light guide 139 will be employed to illuminate the border area of the illumination unit 132. With the appropriate selection of light-emitting diodes, this may result in different illumination colours, preferably in a blue range.

### REFERENCES

1 drive device
2 lower housing part
3 light band
4 drive track
5 mounting base
6 adjoining area
7 housing upper side
8 rounding
9 lateral sections
10 extension
11 transitional area
12 service access
13 mains power supply
14 plug-in connections
15 border area
16 attachment bore
17 frontal side
18 upper housing part
19 attachment bore
20 attachment
21 electromotor connector
22 separating line
23 covering
24 motor attachment
25 underside
26 motor
27 gearbox
28 motor
29 border
30 transformer
31 depression
32 control board
33 control board
34 linking part
35 guiding web
36 projection
37 guiding reception
38 linking part reception
39 attachment bore
40 linking plate
41 attachment points
42 covering
43 screw connection
44 bore
45 locating web
46 force transmitting means
47 strut
48 transmission wheel
49 connecting screw
50 separating line
51 projection
52 bore
53 attachment bore
54 gearbox housing
55 axis reception
56 axis reception
57 motor connector
58 motor connector
59 connecting member
60 axis
61 driving wheel
62 spur gearing
63 retaining element
64 collar
65 extension
66 attachment
67 axis bearing
68 undercut
69 upper side
70 through-opening
71 through-opening
72 exit side
73 sidewall
74 top cover
75 top cover
76 axis
77 extension
78 bore
79 worm
80 gearbox housing
81 worm bearing
82 opening
83 gearbox
84 base bottom
85 sidewall
86 driving wheel
87 measuring wheel
88 spur gearing
89 rotor axis
90 motor extension
91 motor housing
92 spindle insert
93 rotor bearing
94 frontal motor side
95 bearing
96 axis reception
97 bearing
98 axis reception
99 extension
100 worm wheel
101 collar
102 arresting
103 retaining claw
104 connection
105 attachment means
106 groove
107 sidewall
108 base branch
109 carriage
110 catch member
111 attachment
112 light barrier
113 gaps
114 projections
115 drive track lateral part
116 light band
117 interface
118 extension
119 suspension
120 arm assembly
121 suspension
122 attachment
123 control system
124 attachment
125 connecting projection
126 connecting reception
127 radiation unit
128 bottom
129 covering
130 projection
131 radiation surface
132 illumination unit
133 communications field
134 connecting member
135 border
136 reflector
137 frame
138 radiation unit
139 light guide
140 end wall
141 projection

1. A drive device, essentially including a motor and a gearbox and a control system for the automation of a door, preferably a garage door, with a connection to a force transmitting means driven by means of the motor and revolving within the drive track, characterized in that the gearbox includes a worm and is equipped with two opposing motor connectors, to selectively connect at least one of first and second motors, wherein at least one of the first and second motors act upon the common worm, the rotational movement thereof being transferred onto a worm wheel, which directly or indirectly acts in a gearing manner onto the force transmitting means.

2. The drive device according to claim 1, characterized in that the gearbox includes an essentially exterior straight base bottom with opposing sidewalls starting therefrom, between which a frontal wall and, on the opposite side, a partially open exit side with a passage for the force transmitting means is provided, and in that the sidewall is provided with an outward oriented extension, in which the worm is supported and the motor connectors are located, and in that essentially parallel to the base bottom at least one removable straight top cover is provided.

3. The drive device according to claim 1, characterized in that bearings for the reception of axes are included in the base bottom, wherein the worm wheel, which cooperates with the worm, is rotatably supported on the axis and a driving wheel for the force transmitting means is rotatably supported on the axis, wherein the worm wheel and the driving wheel respectively preferably include spur gearings, which serve for the connection to a driving wheel and a transmitting wheel, the teeth systems thereof meshing with each other, wherein the diameter of the driving wheel is larger than the diameter of the transmitting wheel.

4. The drive device according to claim 2, characterized in that the gearbox is attached on a mounting base, which is a component of the housing upper side of an upper housing part, in such a manner that the exit side of the gearbox is disposed in flush alignment to the drive track, wherein, on the mounting base, the drive track via an adjoining area is attached to an extension provided at a frontal side of the drive housing and thereby penetrates into the drive housing.

5. The drive device according to claim 4, characterized in that the drive track is connected to the adjoining area and exchangeable therefrom via a single-part or multi-part attachment means.

6. The drive device according to claim 5, characterized in that the attachment means consist of a latching plug-in connection or of an essentially angled attachment means, which partially or completely overlaps the drive track.

7. The drive device according to claim 1, characterized in that the gearbox is essentially composed of a driving part, which comprises the motor connector and/or, and the worm wheel charged by means of the worm, and the driving wheel which is connected thereto, and of a transmitting part, which essentially consists of the transmitting wheel and the driving wheel, wherein the transmitting part engages in a removable manner into the driving part for a geared connection of the driving wheel to the transmitting wheel.

8. The drive device according to claim 7, characterized in that, at the end of the drive track, the transmitting part is configured as a connecting part for bearing the transmitting wheel with the driving wheel and is connected to the drive track via a linking plate and to be removable therefrom.

9. The drive device according to claim 8, characterized in that the linking plate is provided with retaining projections, which in an upper side of the drive track plunge into through-openings and are non-positively and positively connected thereto, wherein in the connected condition, the drive track abuts against a locating web, and on the other side, the linking plate includes a protruding connecting part, in which the axis for the transmitting wheel and the driving wheel is retained.

10. The drive device according to claim 8, characterized in that the guiding part includes guiding webs, which plunge into the guiding receptions of the gearbox, and in that the connecting part is equipped with projections for the connection to complementary receptions of the gearbox housing.

11. The drive device according to claim 7, characterized in that the driving part and the transmitting part are secured among each other by means of a position stabilization and by means of screw connections.

12. The drive device according to claim 1, characterized in that the drive device includes a measuring device, preferably an incremental encoder for detecting the number of revolutions of the gearbox.

13. The drive device according to claim 12, characterized in that the measuring device is a component of the gearbox and consists of a measuring wheel, which at its circumference includes projections with gaps located there between, which can be detected by a light barrier or in that the measuring device consists of at least one rotating permanent magnet and of a stationary hall generator cooperating therewith.

14. The drive device according to claim 1, characterized in that the housing of the drive device is configured in two-parts in the shape of an upper housing part and a lower housing part, wherein the upper housing part and the lower housing part are connected to each other in a removable manner.

15. The drive device according to claim 14, characterized in that, in the upper housing part, a transformer and control boards are disposed in addition to the gearbox and the motor, and includes a service access, which is accessible from the outside.

16. The drive device according to claim 1, characterized in that the housing upper side is configured to be straight and essentially extends parallel to the housing underside.

17. The drive device according to claim 1, characterized in that the lower housing part is configured as an illumination unit, wherein a planar radiation surface is provided, behind which a reflector is disposed, which is equipped with a radiation unit, which is disposed in or at a frame and consists of light-emitting diodes, which can be controlled by means of a control board.
